(19) United States
(12) Patent Application Publication
(10) Pub. No.: US 2025/0056601 A1
(43) Pub. Date: Feb. 13, 2025

(54) RF SENSING FOR UE POSITIONING USING UPLINK AND DOWNLINK SIGNALS

(71) Applicant: QUALCOMM Incorporated, San Diego, CA (US)

(72) Inventors: Weimin DUAN, San Diego, CA (US); Alexandros MANOLAKOS, Athens, Attikí (GR); Krishna Kiran MUKKAVILLI, San Diego, CA (US)

(21) Appl. No.: 18/717,608

(22) PCT Filed: Dec. 20, 2022
(86) PCT No.: PCT/US2022/081993

§ 371 Date: Jun. 7, 2024

(30) Foreign Application Priority Data
Feb. 9, 2022 (GR) 20220100127

(51) Int. Cl. H04W 74/0808; H04B 7/06; H04W 8/22; H04W 64/00

(52) U.S. Cl. CPC H04W 74/0808; H04B 7/06968; H04W 8/22; H04W 64/00

(57) ABSTRACT

A mobile device is disclosed. The mobile device may receive, from a network node, information indicative of a predetermined time delay to be utilized in connection with an RF sensing procedure utilizing uplink (UL) and downlink (DL) signals. The mobile device may receive an RF sensing reference signal (RS) transmitted by a base station. Responsive to the predetermined time delay elapsing, the mobile device may transmit a corresponding RF sensing RS at a time corresponding to the predetermined time delay after a time at which the RF sensing RS was received, wherein a time at which the corresponding RF sensing RS is received and the predetermined time delay are usable to determine positioning information of the mobile device.

### BACKGROUND

### 1. Field of Disclosure

The present disclosure relates generally to the field of wireless communications, and more specifically to RF sensing.

### 2. Description of Related Art

Various techniques are used to provide positioning information for user devices, each with their own latencies and accuracies. However, it is difficult to provide positioning information with a relatively short latency and with a high accuracy. Moreover, with the increase of 5G and usage of other cellular communications standards, there is increased desire for efficient, high-accuracy positioning information.

### BRIEF SUMMARY

An example method of performing RF sensing, according to this disclosure, comprises receiving, at a User Equipment (UE) from a network node, information indicative of a predetermined time delay to be utilized in connection with an RF sensing procedure utilizing uplink (UL) and downlink (DL) signals. The method also comprises receiving, at the UE, an RF sensing reference signal (RS) transmitted by a base station. The method also comprises, responsive to the predetermined time delay elapsing, transmitting a corresponding RF sensing RS at a time corresponding to the predetermined time delay after a time at which the RF sensing RS was received, wherein a time at which the corresponding RF sensing RS is received and the predetermined time delay are usable to determine positioning information of the UE.

An example method of performing RF sensing, according to this disclosure, comprises receiving, at a base station, configuration information indicating that an RF sensing procedure utilizing uplink (UL) and downlink (DL) signals is to occur. The method also comprises receiving, at the base station, a corresponding RS that was transmitted by a UE responsive to receiving an RF sensing RS and after a predetermined delay time elapsed, wherein the corresponding RS was transmitted in connection with the RF sensing procedure. The method also comprises, based at least in part on the configuration information, either: 1) reporting, to a location server, information indicative of a time the corresponding RS was received, which is usable by the location server to determine a distance between the base station and the UE; or 2) determining, based on the time the corresponding RS was received and the predetermined delay time, the distance between the base station and the UE.

An example mobile device, according to this disclosure, comprises a transceiver, a memory, and one or more processing units communicatively coupled to the transceiver and the memory. The one or more processing units are configured to receive, from a network node, information indicative of a predetermined time delay to be utilized in connection with an RF sensing procedure utilizing uplink (UL) and downlink (DL) signals. The one or more processing units are further configured to receive an RF sensing reference signal (RS) transmitted by a base station. The one or more processing units are further configured to, responsive to the predetermined time delay elapsing, transmit a corresponding RF sensing RS at a time corresponding to the predetermined time delay after a time at which the RF sensing RS was received, wherein a time at which the corresponding RF sensing RS is received and the predetermined time delay are usable to determine positioning information of the mobile device.

An example base station, according to this disclosure, comprises a transceiver, a memory, and one or more processing units communicatively coupled to the transceiver and the memory. The one or more processing units are configured to receive configuration information indicating that an RF sensing procedure utilizing uplink (UL) and downlink (DL) signals is to occur. The one or more processing units are further configured to receive a corresponding RS that was transmitted by a UE responsive to receiving an RF sensing RS and after a predetermined delay time elapsed, wherein the corresponding RS was transmitted in connection with the RF sensing procedure. The one or more processing units are further configured to, based at least in part on the configuration information, either: 1) report, to a location server, information indicative of a time the corresponding RS was received, which is usable by the location server to determine a distance between the base station and the UE; or 2) determine, based on the time the corresponding RS was received and the predetermined delay time, the distance between the base station and the UE.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2 is a diagram of a 5th Generation (5G) New Radio (NR) positioning system, illustrating an embodiment of a positioning system (e.g., the positioning system of FIG. 1) implemented within a 5G NR communication system.

FIG. 3 is a schematic diagram of an example system for performing RF sensing according to an embodiment.

FIG. 4 is a schematic diagram that describes bistatic sensing according to an embodiment.

FIG. 5 is a diagram showing an example of a frame structure for NR and associated terminology.

FIG. 6 is a schematic diagram that illustrates usage of monostatic RF sensing for positioning according to an embodiment.

FIG. 7 is an information flow diagram for positioning using monostatic RF sensing according to an embodiment.

FIG. 8 is a schematic diagram that illustrates usage of bistatic RF sensing for positioning according to an embodiment.

FIG. 9 is an information flow diagram for positioning using bistatic RF sensing according to an embodiment.

FIG. 10 is a flow diagram of a process for determining positioning information using RF sensing, according to an embodiment.

FIG. 11 is a flow diagram of a process for determining positioning information using RF sensing, according to an embodiment.

FIG. 12 is a block diagram of an embodiment of a UE, which can be utilized in embodiments as described herein.

FIG. 13 is a block diagram of an embodiment of a base station, which can be utilized in embodiments as described herein.

FIG. 14 is a block diagram of an embodiment of a computer system, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

With the increased bandwidth allocated for cellular communications standards, e.g., for fifth generation (5G) communication and beyond, techniques that utilize the increased bandwidth for efficient (e.g., low-latency) and accurate positioning information may be implemented. For example, as described herein, an RF sensing procedure that utilizes uplink (UL) and downlink (DL) signals may be implemented to provide positioning information for a UE. Because such UL and DL signals may be relatively wideband in nature, usage of these signals in an RF sensing procedure may allow high accuracy positioning.

In some embodiments, a base station may transmit an RF sensing reference signal (RS). A UE may receive the RF sensing RS, and may transmit a corresponding RF sensing RS. In some examples, the corresponding RF sensing RS may be the same as the RF sensing RS (e.g., having the same waveform, the same comb structure, or the like). In such cases, to avoid having the corresponding RF sensing RS be mistaken as a spatial echo, the UE may be configured to transmit the corresponding RF sensing RS with a predetermined time delay. In other examples, the corresponding RF sensing RS may be another waveform, such as the RF sensing RS with a pre-coded watermark, or a standardized UL signal (e.g., an SRS signal). In some embodiments, the corresponding RF sensing RS may be received by a base station, which may be the same as the base station that transmitted the RF sensing RS (in the case of a monostatic RF sensing procedure) or a different base station (in the case of a bistatic RF sensing procedure). Timing information associated with when the corresponding RF sensing RS is received relative to the time at which the RF sensing RS was transmitted by the base station may be utilized to determine positioning information, as described below in more detail.

By utilizing an RF sensing procedure, which inherently uses wideband signals, for determining positioning information, positioning information may be efficiently determined (e.g., with relatively low latency and by not requiring multiple base stations for triangulation) with high accuracy.

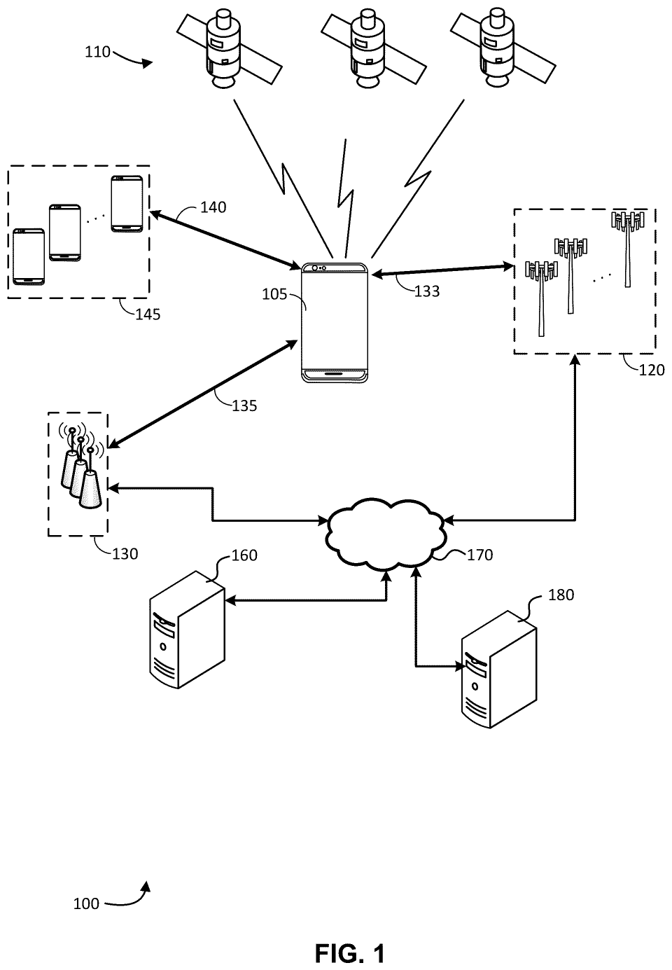

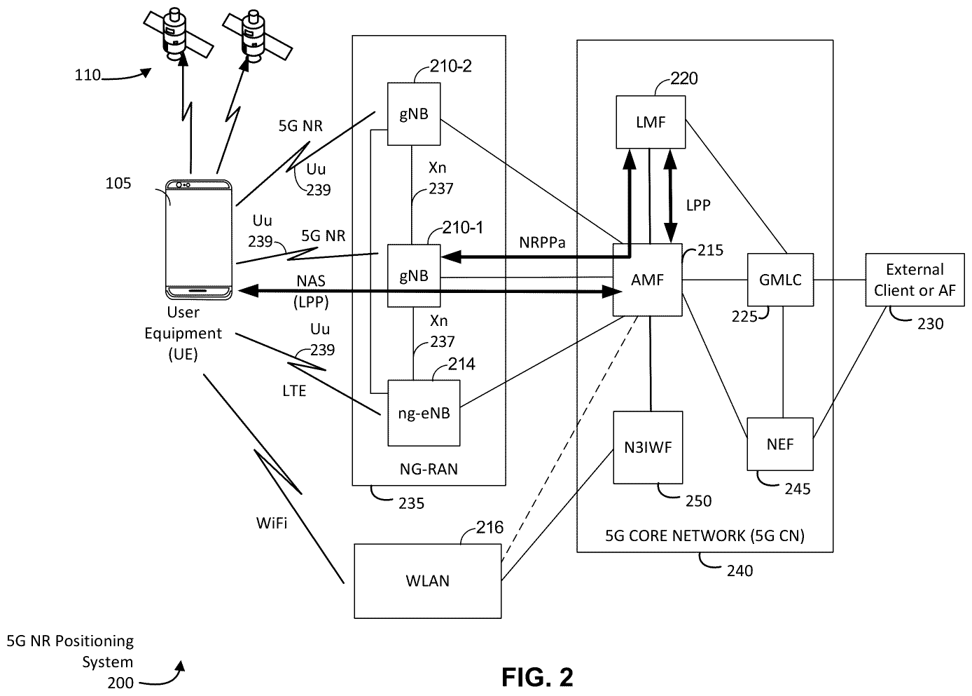

FIG. 1 is a simplified illustration of a positioning system 100 in which a UE 105, location server 160, and/or other components of the positioning system 100 can use the techniques provided herein for performing RF sensing procedures, according to an embodiment. The techniques described herein may be implemented by one or more components of the positioning system 100. The positioning system 100 can include: a UE 105; one or more satellites 110 (also referred to as space vehicles (SVs)) for a Global Navigation Satellite System (GNSS) such as the Global Positioning System (GPS), GLONASS, Galileo or Beidou; base stations 120; access points (APs) 130; location server 160; network 170; and external client 180. Generally put, the positioning system 100 can estimate a location of the UE 105 based on RF signals received by and/or sent from the UE 105 and known locations of other components (e.g., GNSS satellites 110, base stations 120, APs 130) transmitting and/or receiving the RF signals. Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135, or via one or more other UEs 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning system 100 (e.g., GNSS satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other UEs 145, which may be mobile or fixed. When or more other UEs 145 are used in the position determination of a particular UE 105, the UE 105 for which the position is to be determined may be referred to as the “target UE,” and each of the one or more other UEs 145 used may be referred to as an “anchor UE.” For position determination of a target UE, the respective positions of the one or more anchor UEs may be known and/or jointly determined with the target UE. Direct communication between the one or more other UEs 145 and UE 105 may comprise sidelink and/or similar Device-to-Device (D2D) communication technologies. Sidelink, which is defined by 3GPP, is a form of D2D communication under the cellular-based LTE and NR standards.

An estimated location of UE 105 can be used in a variety of applications—e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., the location of a base station 120 or AP 130) or some other location such as a location for UE 105 at some known previous time, or a location of another UE 145 at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, or child or pet location). Additionally or alternatively, the external client 180 may obtain and provide the location of UE 105 to an emergency services provider, government agency, etc.

As previously noted, the example positioning system 100 can be implemented using a wireless communication network, such as an LTE-based or 5G NR-based network. FIG. 2 shows a diagram of a 5G NR positioning system 200, illustrating an embodiment of a positioning system (e.g., positioning system 100) implementing 5G NR. The 5G NR positioning system 200 may be configured to determine the location of a UE 105 by using access nodes 210-1, 210-2, 214, 216 (which may correspond with base stations 120 and access points 130 of FIG. 1) and (optionally) an LMF 220 (which may correspond with location server 160) to implement one or more positioning methods. Here, the 5G NR positioning system 200 comprises a UE 105, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network. The 5G NR positioning system 200 may further utilize information from GNSS satellites 110 from a GNSS system like Global Positioning System (GPS) or similar system (e.g. GLONASS, Galileo, Beidou, Indian Regional Navigational Satellite System (IRNSS)). Additional components of the 5G NR positioning system 200 are described below. The 5G NR positioning system 200 may include additional or alternative components.

It should be noted that FIG. 2 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the 5G NR positioning system 200. Similarly, the 5G NR positioning system 200 may include a larger (or smaller) number of GNSS satellites 110, gNBs 210-1 and 210-2, ng-eNBs 214, Wireless Local Area Networks (WLANs) 216, Access and mobility Management Functions (AMF)s 215, external clients 230, and/or other components. The illustrated connections that connect the various components in the 5G NR positioning system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 105 may correspond to a cellphone, smartphone, laptop, tablet, personal data assistant (PDA), navigation device, Internet of Things (IoT) device, or some other portable or moveable device. Typically, though not necessarily, the UE 105 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 105 may also support wireless communication using a WLAN 216 which (like the one or more RATs, and as previously noted with respect to FIG. 1) may connect to other networks, such as the Internet. The use of one or more of these RATs may allow the UE 105 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 105 (e.g., via the GMLC 225). The external client 230 of FIG. 2 may correspond to external client 180 of FIG. 1, as implemented in or communicatively coupled with a 5G NR network.

The UE 105 may include a single entity or may include multiple entities, such as in a personal area network where a user may employ audio, video and/or data I/O devices, and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude), which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geodetically or in civic form) within which the UE 105 is expected to be located with some probability or confidence level (e.g., 67%, 95%, etc.). A location of the UE 105 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include NR NodeB (gNB) 210-1 and 210-2 (collectively and generically referred to herein as gNBs 210). Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 105 via wireless communication between the UE 105 and one or more of the gNBs 210, which may provide wireless communications access to the 5G CN 240 on behalf of the UE 105 using 5G NR. The wireless interface between base stations (gNBs 210 and/or ng-eNB 214) and the UE 105 may be referred to as a Uu interface 239. 5G NR radio access may also be referred to as NR radio access or as 5G radio access. In FIG. 2, the serving gNB for UE 105 is assumed to be gNB 210-1, although other gNBs (e.g. gNB 210-2) may act as a serving gNB if UE 105 moves to another location or may act as a secondary gNB to provide additional throughput and bandwidth to UE 105.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 105. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 105 but may not receive signals from UE 105 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 105. It is noted that while only one ng-eNB 214 is shown in FIG. 2, some embodiments may include multiple ng-eNBs 214. Base stations 210, 214 may communicate directly with one another via an Xn communication interface. Additionally or alternatively, base stations 210, 214 may communicate directly or indirectly with other components of the 5G NR positioning system 200, such as the LMF 220 and AMF 215.

5G NR positioning system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 105 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 105 to other elements in 5G CN 240 and/or may support interworking of one or more protocols used by WLAN 216 and UE 105 to one or more protocols used by other elements of 5G CN 240 such as AMF 215. For example, N3IWF 250 may support IPSec tunnel establishment with UE 105, termination of IKEv2/IPSec protocols with UE 105, termination of N2 and N3 interfaces to 5G CN 240 for control plane and user plane, respectively, relaying of uplink (UL) and downlink (DL) control plane Non-Access Stratum (NAS) signaling between UE 105 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 105 and the AMF 215. This can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, or WLAN 216 (alone or in combination with other components of the 5G NR positioning system 200), may be configured to, in response to receiving a request for location information from the LMF 220, obtain location measurements of UL signals received from the UE 105) and/or obtain DL location measurements from the UE 105 that were obtained by UE 105 for DL signals received by UE 105 from one or more access nodes. As noted, while FIG. 2 depicts access nodes 210, 214, and 216 configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 105, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 105 may be applicable to such other networks.

The gNBs 210 and ng-eNB 214 can communicate with an AMF 215, which, for positioning functionality, communicates with an LMF 220. The AMF 215 may support mobility of the UE 105, including cell change and handover of UE 105 from an access node 210, 214, or 216 of a first RAT to an access node 210, 214, or 216 of a second RAT. The AMF 215 may also participate in supporting a signaling connection to the UE 105 and possibly data and voice bearers for the UE 105. The LMF 220 may support positioning of the UE 105 using a CP location solution when UE 105 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 105, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 105's location) may be performed at the UE 105 (e.g., by measuring downlink PRS (DL-PRS) signals transmitted by wireless nodes such as gNBs 210, ng-eNB 214 and/or WLAN 216, and/or using assistance data provided to the UE 105, e.g., by LMF 220).

The Gateway Mobile Location Center (GMLC) 225 may support a location request for the UE 105 received from an external client 230 and may forward such a location request to the AMF 215 for forwarding by the AMF 215 to the LMF 220. A location response from the LMF 220 (e.g., containing a location estimate for the UE 105) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 105 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 105 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 105 may communicate using an LTE Positioning Protocol (LPP) as defined in 3GPP TS 37.355. Here, LPP messages may be transferred between the UE 105 and the LMF 220 via the AMF 215 and a serving gNB 210-1 or serving ng-eNB 214 for UE 105. For example, LPP messages may be transferred between the LMF 220 and the AMF 215 using messages for service-based operations (e.g., based on the Hypertext Transfer Protocol (HTTP)) and may be transferred between the AMF 215 and the UE 105 using a 5G NAS protocol. The LPP protocol may be used to support positioning of UE 105 using UE assisted and/or UE based position methods such as A-GNSS, RTK, TDOA, multi-cell RTT, AoD, and/or ECID. The NRPPa protocol may be used to support positioning of UE 105 using network based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 105 access to WLAN 216, LMF 220 may use NRPPa and/or LPP to obtain a location of UE 105 in a similar manner to that just described for UE 105 access to a gNB 210 or ng-eNB 214. Thus, NRPPa messages may be transferred between a WLAN 216 and the LMF 220, via the AMF 215 and N3IWF 250 to support network-based positioning of UE 105 and/or transfer of other location information from WLAN 216 to LMF 220. Alternatively, NRPPa messages may be transferred between N3IWF 250 and the LMF 220, via the AMF 215, to support network-based positioning of UE 105 based on location related information and/or location measurements known to or accessible to N3IWF 250 and transferred from N3IWF 250 to LMF 220 using NRPPa. Similarly, LPP and/or LPP messages may be transferred between the UE 105 and the LMF 220 via the AMF 215, N3IWF 250, and serving WLAN 216 for UE 105 to support UE assisted or UE based positioning of UE 105 by LMF 220.

In a 5G NR positioning system 200, positioning methods can be categorized as being “UE assisted” or “UE based.” This may depend on where the request for determining the position of the UE 105 originated. If, for example, the request originated at the UE (e.g., from an application, or “app,” executed by the UE), the positioning method may be categorized as being UE based. If, on the other hand, the request originates from an external client or AF 230, LMF 220, or other device or service within the 5G network, the positioning method may be categorized as being UE assisted (or “network-based”).

With a UE-assisted position method, UE 105 may obtain location measurements and send the measurements to a location server (e.g., LMF 220) for computation of a location estimate for UE 105. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AoA, Receive Time-Transmission Time Difference (Rx-Tx), Differential AoA (DAoA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 105 if the positions of the other UEs are known. The location measurements may also or instead include measurements for RAT-independent positioning methods such as GNSS (e.g., GNSS pseudorange, GNSS code phase, and/or GNSS carrier phase for GNSS satellites 110), WLAN, etc.

With a UE-based position method, UE 105 may obtain location measurements (e.g., which may be the same as or similar to location measurements for a UE assisted position method) and may further compute a location of UE 105 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 105, and/or may receive measurements obtained by UE 105 or by an AP in WLAN 216 in the case of N3IWF 250, and may send the measurements to a location server (e.g., LMF 220) for computation of a location estimate for UE 105.

Positioning of the UE 105 also may be categorized as UL, DL, or DL-UL based, depending on the types of signals used for positioning. If, for example, positioning is based solely on signals received at the UE 105 (e.g., from a base station or other UE), the positioning may be categorized as DL based. On the other hand, if positioning is based solely on signals transmitted by the UE 105 (which may be received by a base station or other UE, for example), the positioning may be categorized as UL based. Positioning that is DL-UL based includes positioning, such as RTT-based positioning, that is based on signals that are both transmitted and received by the UE 105. Sidelink (SL)-assisted positioning comprises signals communicated between the UE 105 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

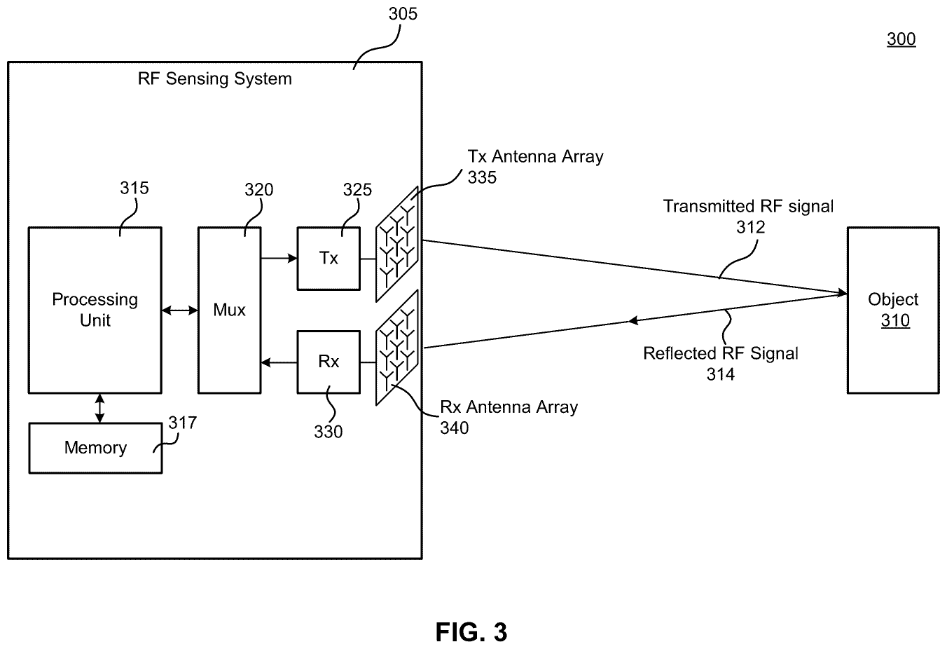

FIG. 3 is a block diagram of an RF sensing system 305 performing radar-based directional proximity sensing, according to an embodiment. As used herein, the terms “waveform” and “sequence” and derivatives thereof are used interchangeably to refer to RF signals generated by a transmitter of the radar system and received by a receiver of the radar system for object detection. A “pulse” and derivatives thereof are generally referred to herein as waveforms comprising a sequence or complementary pair of sequences transmitted and received to generate a CIR. The RF sensing system 305 may comprise a standalone device or may be integrated into a larger electronic device, such as a mobile phone or other device.

With regard to the functionality of the RF sensing system 305 in FIG. 3, the RF sensing system 305 can detect the proximity of an object 310 by generating a series of transmitted RF signals 312 (comprising one or more pulses). Some of these transmitted RF signals 312 reflect off of the object 310, and these reflected RF signals 314 are then processed by the radar system 305 using BF and DSP techniques (including leakage cancellation) to determine the object's location (azimuth, elevation, velocity, and range) relative to the RF sensing system 305. Because embodiments may implement a flexible FOV, the RF sensing system 305 can detect an object 310 within a select volume of space. This volume of space can be defined by a range of azimuths, elevations, and distances from the RF sensing system 305. (As described below, this volume of space may also be defined by an FOV (a range of azimuths and elevations) and a range of distances within the FOV or from an area of interest corresponding to the FOV.)

To enable RF sensing proximity detecting, RF sensing system 305 includes a processing unit 315, memory 317, multiplexer (mux) 320, Tx processing circuitry 325, and Rx processing circuitry 330. (The RF sensing system 305 may include additional components not illustrated, such as a power source, user interface, or electronic interface) It can be noted, however, that these components of the RF sensing system 305 may be rearranged or otherwise altered in alternative embodiments, depending on desired functionality. Moreover, as used herein, the terms “transmit circuitry” or “Tx circuitry” refer to any circuitry utilized to create and/or transmit the transmitted RF signal 312. Likewise, the terms “receive circuitry” or “Rx circuitry” refer to any circuitry utilized to detect and/or process the reflected RF signal 314. As such, “transmit circuitry” and “receive circuitry” may not only comprise the Tx processing circuitry 325 and Rx processing circuitry 330 respectively, but may also comprise the mux 320 and processing unit 315. In some embodiments, the processing unit may compose at least part of a modem and/or wireless communications interface. In some embodiments, more than one processing unit may be used to perform the functions of the processing unit 315 described herein.

The Tx processing circuitry 325 and Rx circuitry 330 may comprise subcomponents for respectively generating and detecting RF signals. As a person of ordinary skill in the art will appreciate, the Tx processing circuitry 325 may therefore include a pulse generator, digital-to-analog converter (DAC), a mixer (for up-mixing the signal to the transmit frequency), one or more amplifiers (for powering the transmission via Tx antenna array 335), etc. The Rx processing circuitry 330 may have similar hardware for processing a detected RF signal. In particular, the Rx processing circuitry 330 may comprise an amplifier (for amplifying a signal received via Rx antenna 340), a mixer for down-converting the received signal from the transmit frequency, an analog-to-digital converter (ADC) for digitizing the received signal, and a pulse correlator providing a matched filter for the pulse generated by the Tx processing circuitry 325. The Rx processing circuitry 330 may therefore use the correlator output as the CIR, which can be processed by the processing unit 315 (or other circuitry) for leakage cancellation as described herein. Other processing of the CTR may also be performed, such as object detecting, range, speed, or direction of arrival (DoA) estimation.

BF is further enabled by a Tx antenna array 335 and Rx antenna array 340. Each antenna array 335, 340 comprises a plurality of antenna elements. It can be noted that, although the antenna arrays 335, 340 of FIG. 3 include two-dimensional arrays, embodiments are not so limited. Arrays may simply include a plurality of antenna elements along a single dimension that provides for spatial cancellation between the Tx and Rx sides of the RF sensing system 305. As a person of ordinary skill in the art will appreciate, the relative location of the Tx and Rx sides, in addition to various environmental factors can impact how spatial cancellation may be performed.

It can be noted that the properties of the transmitted RF signal 312 may vary, depending on the technologies utilized. Techniques provided herein can apply generally to “mmWave” technologies, which typically operate at 57-71 GHz, but may include frequencies ranging from 30-300 GHz. This includes, for example, frequencies utilized by the 802.11ad Wi-Fi standard (operating at 60 GHz). That said, some embodiments may utilize radar with frequencies outside this range. For example, in some embodiments, 5G frequency bands (e.g., 28 GHz) may be used. Because radar may be performed in the same busy bands as communication, hardware may be utilized for both communication and RF sensing, as previously noted. For example, one or more of the components of the RF sensing system 305 shown in FIG. 3 may be included in a wireless modem (e.g., Wi-Fi or 5G modem). Additionally, techniques may apply to RF signals comprising any of a variety of pulse types, including compressed pulses (e.g., comprising Chirp, Golay, Barker, or Ipatov sequences) may be utilized. That said, embodiments are not limited to such frequencies and/or pulse types. Additionally, because the radar system may be capable of sending RF signals for communication (e.g., using 802.11 communication technology), embodiments may leverage channel estimation used in communication for performing proximity detection as provided herein. Accordingly, the pulses may be the same as those used for channel estimation in communication.

As noted, the RF sensing system 305 may be integrated into an electronic device in which proximity detecting is desired. For example, the RF sensing system 305, which can perform RF sensing-based proximity detecting, may be part of communication hardware found in modern mobile phones. Other devices, too, may utilize the techniques provided herein. These can include, for example, other mobile devices (e.g., tablets, portable media players, laptops, wearable devices, virtual reality (VR) devices, augmented reality (AR) devices), as well as other electronic devices (e.g., security devices, on-vehicle systems). That said, electronic devices into which a RF sensing system 305 may be integrated are not limited to mobile devices. Furthermore, RF sensing-based proximity sensing as described herein may be performed by a RF sensing system 305 that may not be otherwise used in wireless communication.

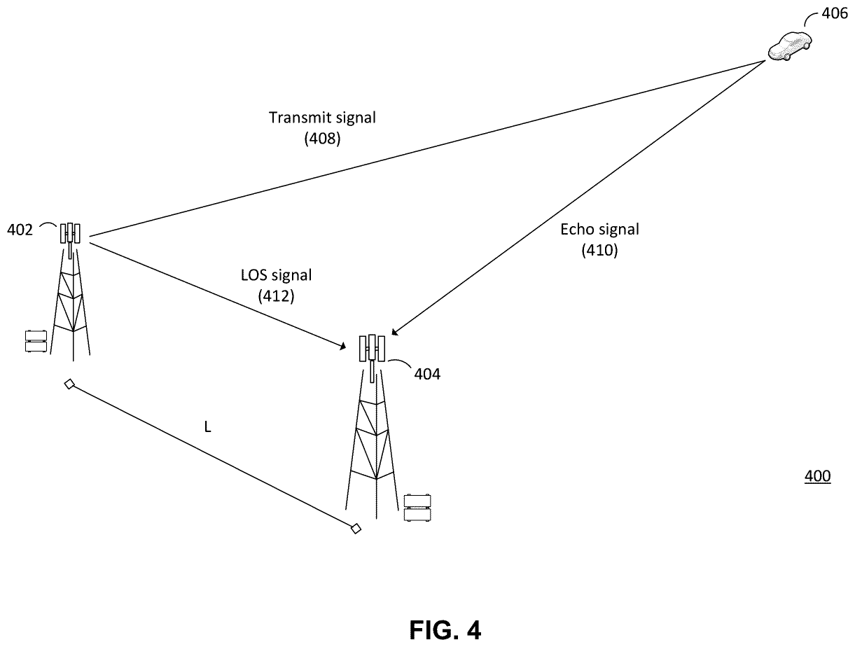

FIG. 4 illustrates the implementation of the bistatic RF sensing system 300 in a wireless communications system, according to an embodiment of the disclosure. The wireless communications system may comprise a wireless communication system 400, as shown in FIG. 4. The wireless communications system 400 may comprise numerous Transmission Reception Points (TRPs), which provide transmission and/or reception of signals with other devices. Examples of TRPs within the wireless communications system 400 include base stations 402 and 404, which serve to provide wireless communications for user equipment (UE) such as vehicles, wireless phones, wearable device, personal access points, and a plethora of other types of user devices in the vicinity that require wireless data communications. For instance, base stations 402 and 404 may be configured to support data communications with a UE device, by transmitting data symbols to or receiving data symbols from the UE device. Resources within the wireless communication system 400, such as base station 402 and 404, may thus be utilized to serve “double duty” to support not only wireless communication operations but also bistatic and/or multi-static radar operations. The wireless communications system 400 may be a cellular communications system

For example, base stations 402 and base station 404 may serve as the transmitter and receiver, respectively, of the bistatic radar system 400 shown in FIG. 4. Base station 402 may transmit the transmit signal 408, which reflects from target 406 and becomes the echo signal 410 received by the base stations 404. The base station 404 may also receive a line-of-sight (LOS) signal 412 from the base station 402. By receiving both the LOS signal 412 and the echo signal 410, the RX base station 404 can measure the value associated with the time difference between the reception times T_{Rx_echo} and T_{RxLOS} associated with the reception of the echo signal 410 and the LOS signal 412, respectively. For example, the RX base station 404 may cross-correlate the received LOS signal 412 with the received echo signal 410, such as by mixing the two signals in analog or digital form, to yield a value representative of the time difference (T_{Rx_echo}−T_{RxLOS}). The time difference can be used to find the total distance Rₛᵤₘ. The total distance Rₛᵤₘ can then be used to define an ellipsoid surface, which along with other information may be used to find the target range R_{R}, angle of arrival (AoA) θ_{R}, and/or Doppler frequency associated with the target 406.

Here, target 406 may be, but does not have to be, a UE that is being supported by the wireless communications system 400. In some instances, target 406 may be a UE that is configured to transmit and receive wireless signals carrying voice, text, and/or wireless data using the base stations of wireless communications system 400. In other instances, target 406 may simply be a remote object that is within the bistatic radar range of base station 402 and base station 404 but otherwise has nothing to do with the wireless communications functions of system 400.

In the bistatic example shown in FIG. 4, the transmitter is referred to as the Tx base station 402, and the receiver is referred to as the Rx base station 404. More generally, Tx base station 402 may be referred to as a Tx TRP, and Rx base station 404 may be referred to as a Rx TRP. Here “Tx” and “Rx” merely refer to the fact that base station 402 is used to transmit the RF sensing signal 408, and the base station 404 is used to receive the echoed RF sensing signal 410. The terms “Tx” and “Rx” in this context do not limit the operation of the base stations 402 and 404 to serve other functions, e.g., to serve as transmitter and/or receiver in other bistatic or multi-static radar operations (beyond what is illustrated in FIG. 4) or as base stations transmitting and receiving data communications in the normal operation of the wireless communications system 400. While FIG. 4 illustrates a simple bistatic RF sensing system, a multi-static RF sensing system may also be implemented within a wireless communications system in a similar manner. Also, while FIG. 4 illustrates a simple example in two-dimensional space, the same operations can be extended to three-dimensional space.

Implementing a bistatic or multi-static RF sensing system within a wireless communications system according to embodiments of the present disclosure may yield numerous benefits. One particular benefit is the flexible utilization of bandwidth allocated for wireless communications. An example of the wireless communications system 400 is a cellular communications system. For example, according to one embodiment, the wireless communications system 400 may conform to the “5G” standard. Ever increasing bandwidth allotted to present and future wireless communications systems, including 5G and 5G beyond, may be leveraged for the transmission of bistatic and multi-static RF sensing signals. Thus, radio frequency (RF) sensing may be enabled by utilizing available wireless RF spectrum resource. For example, one or more of the transmit signal 408, echo signal 410, and/or LOS signal 412 may occupy bandwidth within a portion of radio frequency (RF) spectrum allocated to the wireless communications system 400 for data communications. Another example of the wireless communications system 400 is a Long-Term Evolution (LTE) wireless communications system. Other examples of the wireless communications system 400 include a wireless local area network (WLAN), a wireless wide area network (WWAN), a small cell-based wireless communications system, a millimeter wave-based (mmwave-based) communications system, and other types of communications based systems that include TRPs.

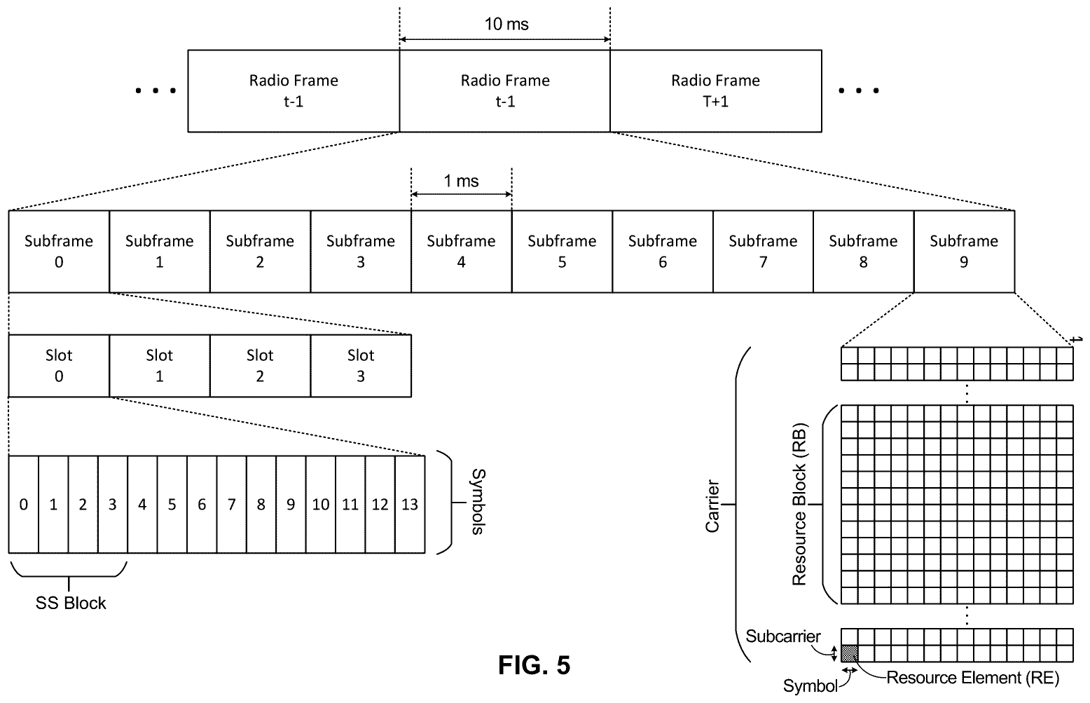

FIG. 5 is a diagram showing an example of a frame structure for NR and associated terminology, which can serve as the basis for physical layer communication between the UE 105 and base stations/TRPs. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices. A mini slot may comprise a sub slot structure (e.g., 2, 3, or 4 symbols). Additionally shown in FIG. 5 is the complete Orthogonal Frequency-Division Multiplexing (OFDM) of a subframe, showing how a subframe can be divided across both time and frequency into a plurality of Resource Blocks (RBs). A single RB can comprise a grid of Resource Elements (REs) spanning 14 symbols and 12 subcarriers.

Each symbol in a slot may indicate a link direction (e.g., DL, UL, or flexible) or data transmission and the link direction for each subframe may be dynamically switched. The link directions may be based on the slot format. Each slot may include DL/UL data as well as DL/UL control information. In NR, a synchronization signal (SS) block is transmitted. The SS block includes a primary SS (PSS), a secondary SS (SSS), and a two symbol Physical Broadcast Channel (PBCH). The SS block can be transmitted in a fixed slot location, such as the symbols 0-3 as shown in FIG. 5. The PSS and SSS may be used by UEs for cell search and acquisition. The PSS may provide half-frame timing, the SS may provide the cyclic prefix (CP) length and frame timing. The PSS and SSS may provide the cell identity. The PBCH carries some basic system information, such as downlink system bandwidth, timing information within radio frame, SS burst set periodicity, system frame number, etc.

As discussed herein, in some embodiments, TDOA assistance data may be provided to a UE 105 by a location server (e.g., location server 160) for a “reference cell” (which also may be called “reference resource”), and one or more “neighbor cells” or “neighboring cells” (which also may be called a “target cell” or “target resource”), relative to the reference cell. For example, the assistance data may provide the center channel frequency of each cell, various PRS configuration parameters (e.g., N_{PRS}, T_{PRS}, muting sequence, frequency hopping sequence, PRS ID, PRS bandwidth), a cell global ID, PRS signal characteristics associated with a directional PRS, and/or other cell related parameters applicable to TDOA or some other position method. PRS-based positioning by a UE 105 may be facilitated by indicating the serving cell for the UE 105 in the TDOA assistance data (e.g., with the reference cell indicated as being the serving cell).

In some embodiments, TDOA assistance data may also include “expected Reference Signal Time Difference (RSTD)” parameters, which provide the UE 105 with information about the RSTD values the UE 105 is expected to measure at its current location between the reference cell and each neighbor cell, together with an uncertainty of the expected RSTD parameter. The expected RSTD, together with the associated uncertainty, may define a search window for the UE 105 within which the UE 105 is expected to measure the RSTD value. TDOA assistance information may also include PRS configuration information parameters, which allow a UE 105 to determine when a PRS positioning occasion occurs on signals received from various neighbor cells relative to PRS positioning occasions for the reference cell, and to determine the PRS sequence transmitted from various cells in order to measure a signal ToA or RSTD.

Using the RSTD measurements, the known absolute or relative transmission timing of each cell, and the known position(s) of wireless node physical transmitting antennas for the reference and neighboring cells, the UE position may be calculated (e.g., by the UE 105 or by the location server 160). More particularly, the RSTD for a neighbor cell “k” relative to a reference cell “Ref,” may be given as (ToAₖ−ToA_{Ref}), where the ToA values may be measured modulo one subframe duration (1 ms) to remove the effects of measuring different subframes at different times. ToA measurements for different cells may then be converted to RSTD measurements and sent to the location server 160 by the UE 105. Using (i) the RSTD measurements, (ii) the known absolute or relative transmission timing of each cell, (iii) the known position(s) of physical transmitting antennas for the reference and neighboring cells, and/or (iv) directional PRS characteristics such as a direction of transmission, the UE 105 position may be determined.

In some implementations, positioning information of a UE can be determined using a monostatic RF sensing procedure. For example, in some implementations, a base station (e.g., a gNb, or any other suitable base station) can transmit an RF sensing RS. In response to receiving the RF sensing RS transmitted by the base station, a UE can wait a predetermined (e.g., preconfigured) delay time period, generally referred to herein as δ, and can transmit a corresponding RS after the predetermined delay time period has elapsed. The base station can then receive the corresponding RS. Positioning information of the UE, such as a distance between the UE and the base station, may be determined based on a time at which the base station receives the corresponding RS and the predetermined delay time period. It should be noted that, in some implementations, the base station may determine the distance between the UE and the base station. Additionally or alternatively, in some implementations, the base station may report to a server (e.g., a location server, an RF sensing server, or the like) a duration of time elapsed between the time the RF sensing RS was transmitted by the base station and the time the corresponding RS was received by the base station. Continuing with this example, the server may determine the distance between the UE and the base station based on the duration of time elapsed received from the base station and a priori information indicating the predetermined delay time period.

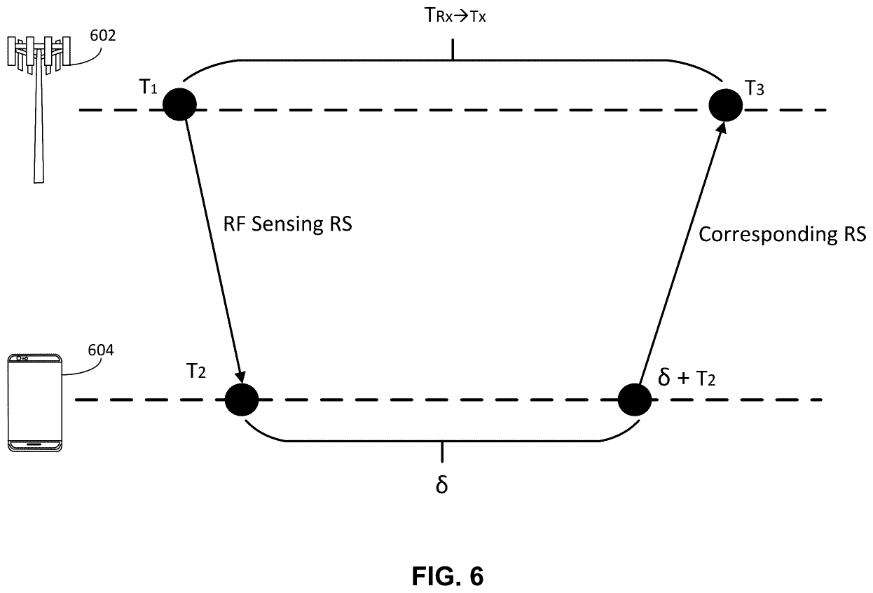

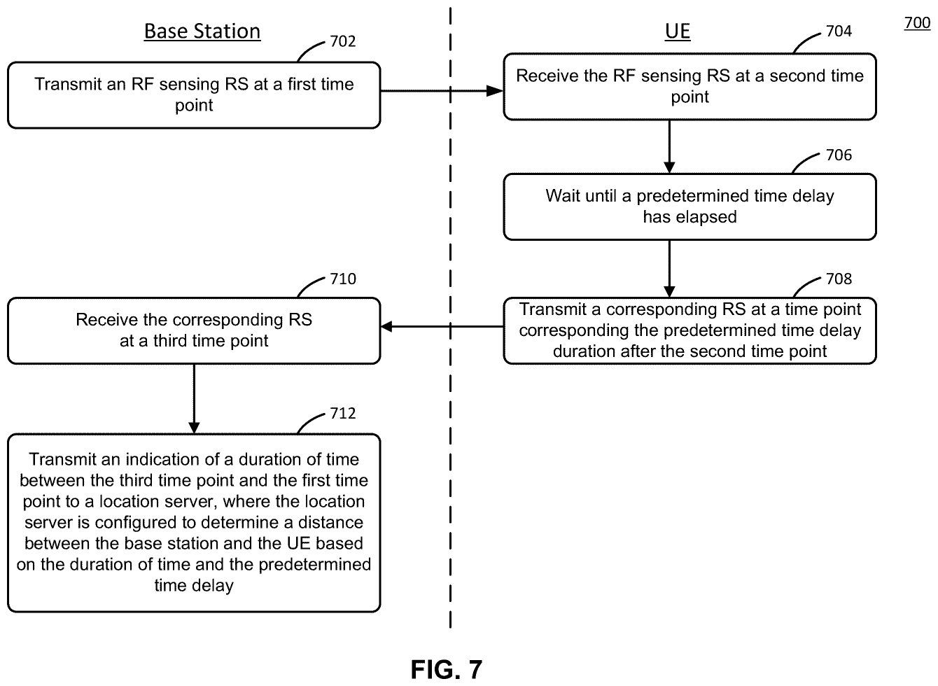

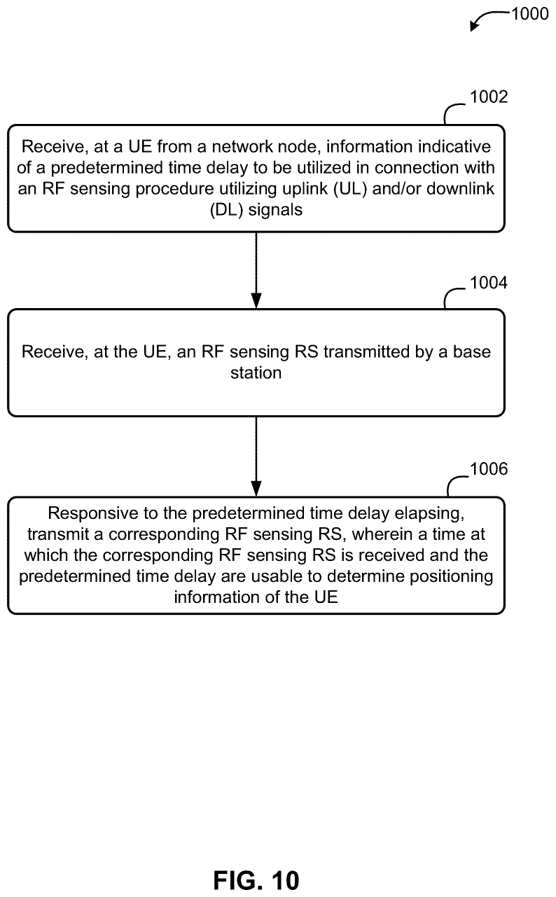

FIG. 6 shows an example usage of RF sensing utilizing a monostatic configuration according to an embodiment. As illustrated, at T₁, a base station 602 transmits an RF sensing RS. At T₂, a UE 604 receives the RF sensing RS. UE 604 waits a predetermined delay time period δ. At time T₂+δ, UE 604 transmits a corresponding RS. It should be noted that the predetermined time delay period may be selected such that the corresponding RS transmitted by UE 604 is not mistaken for a spatial echo of the RF sensing RS. As described below in more detail in connection with FIGS. 7 and 10, the corresponding RS may substantially correspond to the RF sensing RS received by UE 604 from base station 602. In one example, the corresponding RS may have the same waveform as the RF sensing RS. In another example, the corresponding RS may have the same OFDM blocks as the RF sensing RS. Alternatively, in some implementations the corresponding RS may be different from the RF sensing RS. For example, in some implementations, the corresponding RS may be the RF sensing RS with a preceded watermark that distinguishes the corresponding RS from a spatial echo of the RF sensing RS. As another example, in some implementations, the corresponding RS may be the an uplink RS, such as SRS. It should be noted that, in instances in which the corresponding RS is different from the RF sensing RS, the corresponding RS may be transmitted without a predetermined delay time period. In other words, in such instances, the predetermined time delay δ may be 0.

Base station 602 receives the corresponding RS at T₃. In some implementations, base station 602 reports (e.g., transmits) an indication of the time duration between a time the RF sensing RS was transmitted and the time the corresponding RS was received (e.g., T₃−T₁) to a server, and the server is configured to determine the distance between UE 604 and base station 602, where the server has a priori knowledge of δ. Alternatively, in some implementations, base station 602 is configured to determine the distance between UE 604 and base station 602 using the time duration T₃−T₁ and δ.

In some implementations, the distance between UE 604 and base station 602, generally referred to herein as d, can be determined as:

$$d = \frac{1}{2 c} ( {T}_{3} - {T}_{1} ) - \frac{1}{2 c} ( δ )$$

In the equation given above, c represents the speed of light in meters per second.

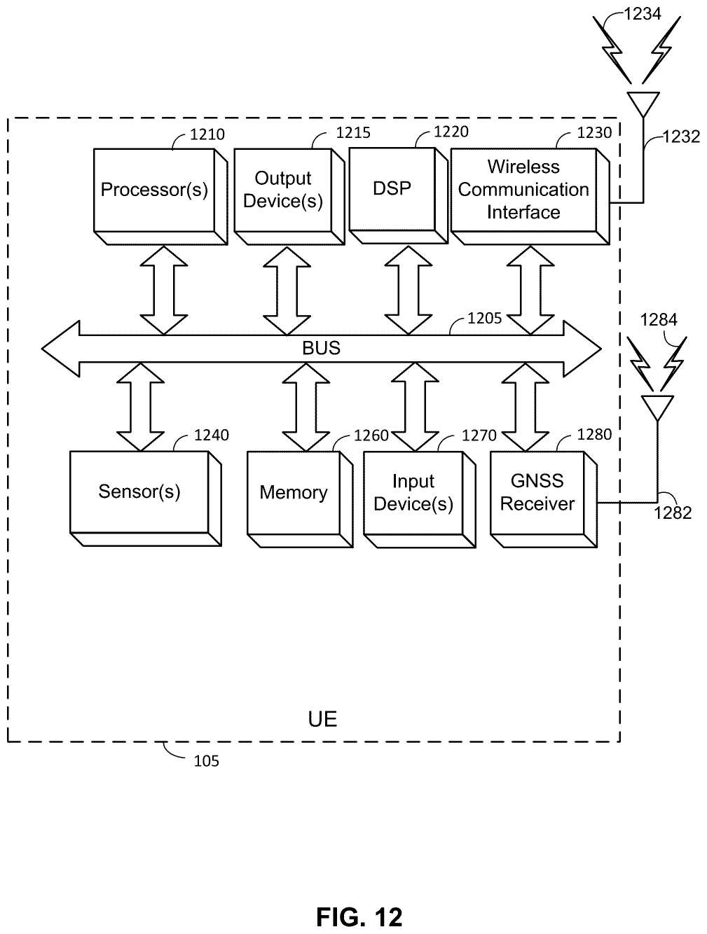

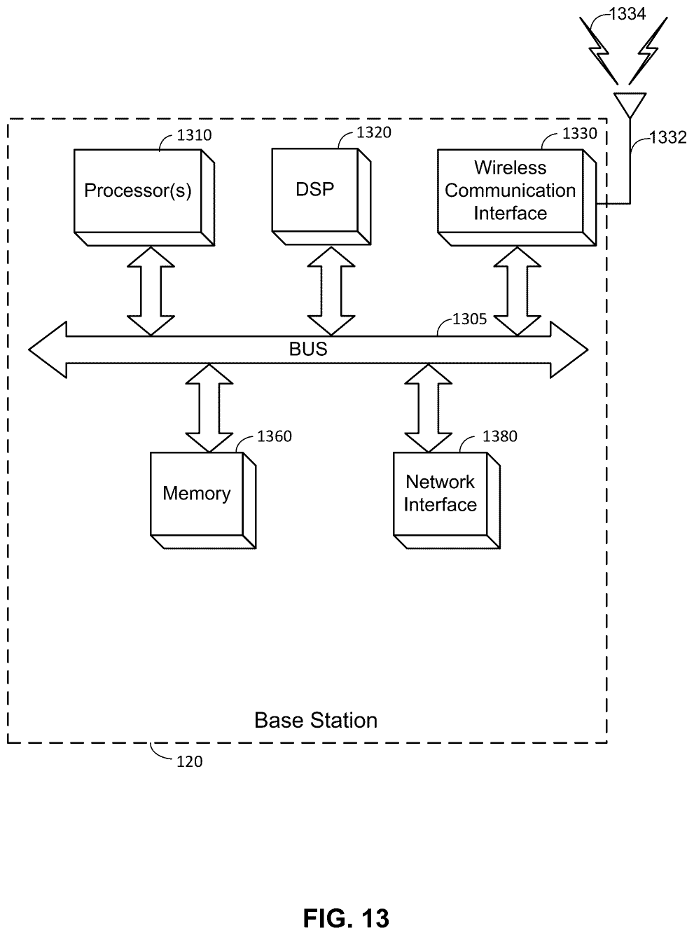

FIG. 7 shows an example information flow diagram of a process 700 for determining positioning information using a monostatic RF sensing procedure, according to an embodiment. Means for performing the functionality illustrated in one or more of the blocks shown in FIG. 7 may be performed by hardware components of a base station and/or a UE. Example components of a UE and a base station are illustrated in FIGS. 12 and 13, respectively, which are described in more detail below.

At block 702, the functionality comprises transmitting, by the base station, an RF sensing RS at a first time point. Means for performing the functionality at block 702 comprise one or more hardware processors, one or more antennas, and/or other components of a base station, as illustrated in FIG. 13.

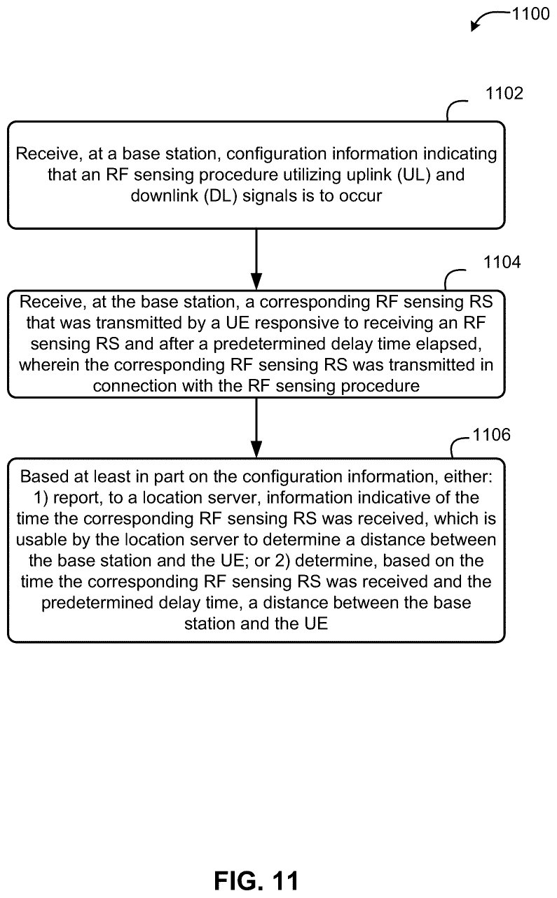

It should be noted that, in some implementations, the RF sensing RS may be transmitted by the base station responsive to an application function initiating the sensing procedure (e.g., to obtain positioning information of the UE). The application function may be associated with a network entity (e.g., for network optimization purposes, such as adaptive beamforming), may be an application executing on the UE device, or an external entity or application. In some implementations, a request to initiate the sensing procedure may be transmitted to an intermediate server (e.g., a location server and/or any suitable server device that performs a sensing management function (SnMF)). The intermediate server may configure the base station (e.g., as shown in and described below in connection with FIG. 11) and/or may cause the base station to transmit the RF sensing RS at block 702.

At block 704, the functionality comprises receiving, by the UE, the RF sensing RS at a second time point. Means for performing the functionality at block 704 comprise one or more hardware processors, one or more antennas, and/or any other components of a UE, as illustrated in FIG. 12.

At block 706, the functionality comprises the UE waiting until a predetermined time delay has elapsed. Means for performing the functionality at block 706 comprise one or more hardware processors, and/or any other components of a UE, as illustrated in FIG. 12. In some implementations, the predetermined time delay may be obtained by the UE in any suitable manner. For example, in some implementations, the UE may receive configuration information indicative of the predetermined time delay. The configuration information may be received from the base station, from a location server, from an RF sensing server, and/or from any other suitable entity. It should be noted that, prior to block 706, the UE may perform various calibration techniques to ensure that the UE is capable of accurately measuring elapse of the predetermined time delay and/or transmitting a signal after the predetermined time delay has elapsed. Moreover, it should be noted that the predetermined time delay may be selected such that a corresponding RS transmitted at block 708 is not identified as a spatial echo of the RF sensing RS, as described in more detail in connection with block 708.

At block 708, the functionality comprises the UE transmitting a corresponding RS at a time point corresponding to the predetermined time delay duration after the second time point (e.g., after the time point at which the UE received the RF sensing RS at block 704). Means for performing the functionality at block 708 comprise one or more hardware processors, one or more antennas, and/or any other components of a UE, as illustrated in FIG. 12.

In some implementations, the corresponding RS may have a waveform that is substantially similar to or the same as the RF sensing RS transmitted by the base station. For example, in some implementations, the corresponding RS may have the same comb structure as the RF sensing RS and/or the same waveform as the RF sensing RS. In some implementations, the corresponding RS may have a watermark or other coding applied that distinguishes the corresponding RS from an echo of the RF sensing RS off of various passive objects. In one example, a watermark may comprise a phase shift of resource blocks of an OFDM communication scheme utilized in the RF sensing RS. As a more particular example, in some implementations, the same phase shift may be applied to all resource elements. As another more particular example, in some implementations, each resource block of the OFDM communication scheme may have a different amplitude or phase shift. In some implementations, the corresponding RS may be a legacy uplink signal, such as SRS. In some embodiments, a format of the corresponding RS may be indicated in configuration settings obtained by or received by the UE (e.g., from the base station, from a location server, from an RF sensing server, or the like).

It should be noted that, in instances in which the corresponding RS is different than the RF sensing RS (e.g., due to having a watermark or other precoding scheme, due to being a legacy uplink signal, or the like), the predetermined time delay utilized in block 706 may be 0 or near 0, because, in such instances, the corresponding RS will not be mistaken as a spatial echo of the RF sensing RS. Moreover, in such instances, the base station may be configured to have a priori knowledge of a structure of the corresponding RS (e.g., that the corresponding RS will utilize a particular watermarking scheme, the corresponding RS will be a particular type of legacy uplink signal, or the like).

At 710, the functionality comprises the base station receiving the corresponding RS at a third time point. Means for performing the functionality at block 710 comprise one or more hardware processors, one or more antennas, and/or other components of a base station, as illustrated in FIG. 13.

At 712, the functionality comprises the base station transmitting an indication of a duration of time between the third time point and the first time point to a location server, where the location server is configured to determine a distance between the base station and the UE based on the duration of time and the predetermined time delay. Means for performing the functionality at block 712 comprise one or more hardware processors, one or more antennas, and/or any other components of a base station, as illustrated in FIG. 13.

In some implementations, the location server may be configured to determine the distance between the base station and the UE, for example, utilizing the techniques shown in and described above in connection with FIG. 6. It should be noted that, in some implementations, the base station itself may be configured to determine the distance between the base station and the UE. In such embodiments, the base station may not transmit the indication of the duration of time between the third time point and the first time point to the location server.

In some implementations, positioning information of a UE may be determined utilizing a bistatic RF sensing procedure that includes a first base station (e.g., a Tx base station), a second base station (e.g., an Rx base station), and a UE. For example, in some embodiments, the first base station can transmit an RF sensing RS at a first time point. The UE may receive the RF sensing RS at a second time point. The UE may wait a predetermined time delay δ, and, responsive to the predetermined time delay elapsing, the UE may transmit a corresponding RS. The corresponding RS may be received by the second base station at a third time point. The distance between the second base station (e.g, the Rx base station) and the UE may be determined based at least in part on a difference between a time at which the second base station receives the corresponding RS and a time at which the second base station receives the RF sensing RS transmitted by the first base station, the predetermined time delay, and/or a distance between the first base station and the second base station. It should be noted that, similar to what is described above in connection with FIGS. 6 and 7, in instances in which the corresponding RS differs from the RF sensing RS (e.g., by utilizing a particular watermarking or precoding scheme, by utilizing a legacy uplink signal, or the like), the predetermined time delay may be 0 or near 0, because the corresponding RS in such instances will not be mistaken as a spatial echo of the RF sensing RS.

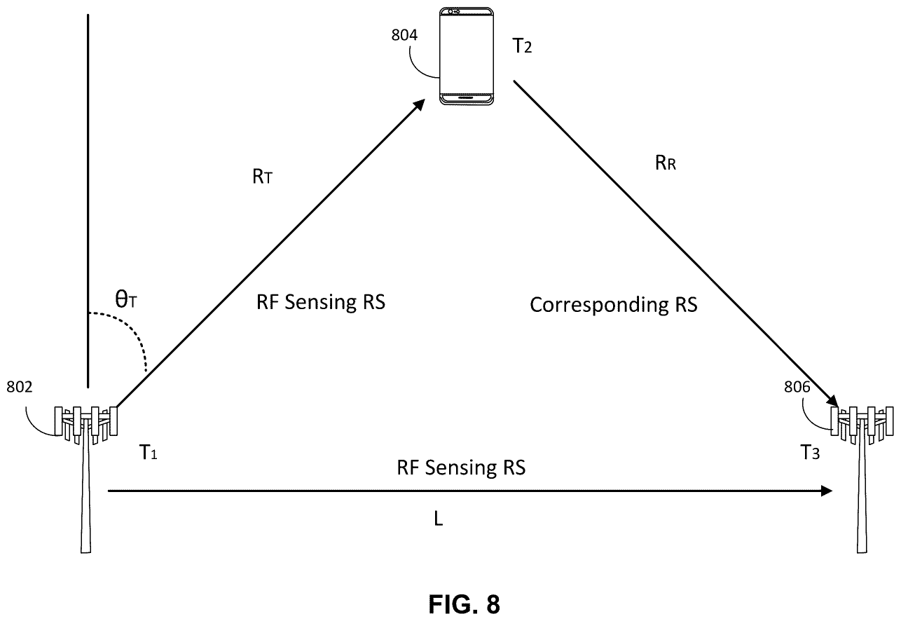

FIG. 8 shows an example usage of an RF sensing procedure utilizing a bistatic configuration, according to an embodiment. As illustrated, at time T₁, a first base station 802 (e.g., the Tx base station) transmits an RF sensing RS. At time T₂, a UE 804 receives the RF sensing RS. It should be noted that the range between UE 804 and first base station 802 is denoted as R_{T} in FIG. 8. After a predetermined time delay δ, UE 804 may transmit a corresponding RS at a time point T₂+δ. A second base station 806 (e.g., the Rx base station) may receive the corresponding RS at a time T₃. It should be noted that the range between UE 804 and second base station 806 is denoted as R_{R} in FIG. 8. Accordingly, the range sum Rₛᵤₘ=R_{T}+R_{R}, where the range sum may position the UE on the surface of an ellipsoid whose foci are the first base station 802 and the second base station 806.

In some embodiments, R_{R}, the distance between second base station 806 and UE 804, may be determined using the following technique(s). Rₛᵤₘ may be determined based on the time the corresponding RS is received by second base station 806 (referred to herein as T_{Rx_correspond}), the time the RF sensing RS is received by second base station 806 (referred to herein as T_{Rx_RF}), the predetermined time delay (referred to herein as δ), and a distance between first base station 802 and second base station 806 (referred to herein as L). In one example, Rₛᵤₘ=(T_{RXcorrespond}−T_{RX}_{_{RF}} δ)*c+L, where c represents the speed of light.

Continuing with this example, the distance between UE 804 and first base station 802, R_{T}, may be determined based on Rₛᵤₘ. In one example, R_{T} may be determined using an AoD of the RF sensing RS from first base station 802, denoted as ⊖_{T}. In one particular example,

$${R}_{T} = {R}_{sum} - \frac{{R}_{sum}^{2} - {L}^{2}}{2 ( {R}_{sum} + L * cos {θ}_{T} )} ,$$

where L represents the distance between first base station 802 and second base station 806. In some implementations the AoD of the RF sensing RS may be determined by RSRP measurements reported by UE 804. Continuing still further with this example, the distance between UE 804 and second base station 806 may be determined as R_{R}=Rₛᵤₘ−R_{T}.

It should be noted that, in some implementations, R_{T} may be determined using techniques other than utilizing the AoD of the RF sensing RS. For example, in some implementations, R_{T} may be determined based on an AoA of the corresponding RS at second base station 806. As another example, in some implementations, rather than utilizing only one Rx base station as shown in FIG. 8, in some implementations, multiple Rx base stations may be utilized to triangulate a position of UE 804 based on the corresponding RS received at each of the multiple Rx base stations.

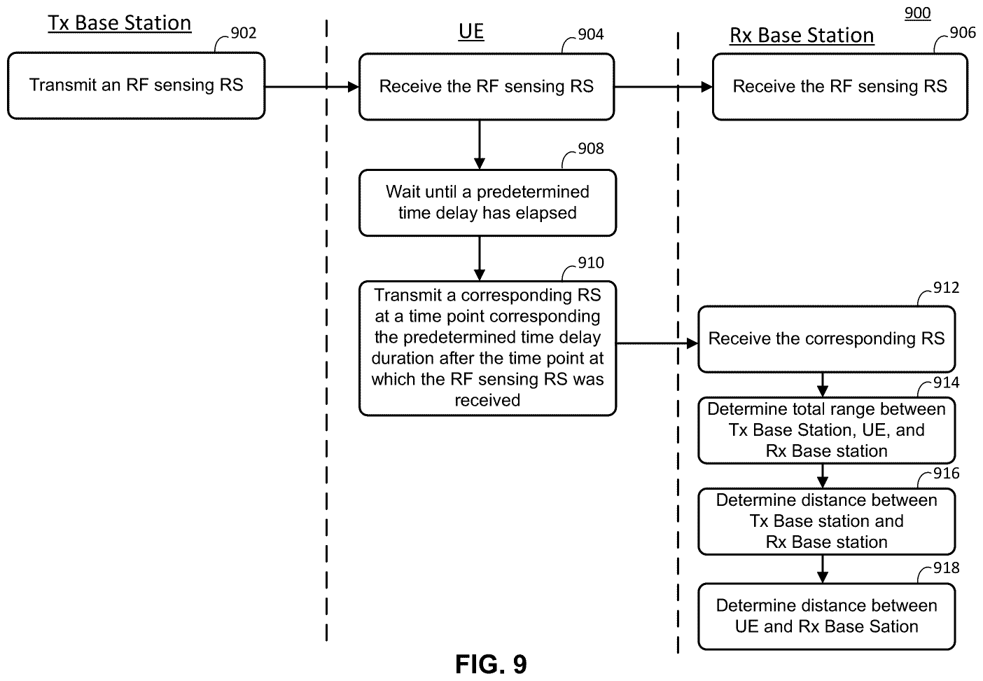

FIG. 9 shows an example information flow diagram of a process 900 for determining positioning information using a bistatic RF sensing procedure, according to an embodiment. Means for performing the functionality illustrated in one or more of the blocks shown in FIG. 9 may be performed by hardware components of a Tx base station, a UE, and/or an Rx base station. Example components of a UE and a base station (whether a Tx base station or an Rx base station) are illustrated in FIGS. 12 and 13, respectively, which are described in more detail below.

At 902, the functionality comprises transmitting, by the Tx base station, an RF sensing RS. Means for performing the functionality of block 902 comprise one or more hardware processors, one or more antennas, and/or any other components of a base station, as shown in FIG. 13.

At 904, the functionality comprises receiving, by the UE, the RF sensing RS. Means for performing the functionality of block 904 comprise one or more hardware processors, one or more antennas, and/or any other components of a UE, as shown in FIG. 12.

At 906, the functionality comprises receiving, by the Rx base station, the RF sensing RS. Means for performing the functionality of block 906 comprise one or more hardware processors, one or more antennas, and/or any other components of a base station, as shown in FIG. 13.

It should be noted that, in some implementations, blocks 904 and 906 may occur in any order. Moreover, in some implementations, the UE may proceed to block 908 without any knowledge that the Rx base station has received the RF sensing RS at block 906.

At 908, the functionality comprises waiting until a predetermined time delay has elapsed. Means for performing the functionality of block 908 comprise one or more hardware processors, and/or any other components of a UE, as shown in FIG. 12. In some implementations, the predetermined time delay may be determined or obtained by the UE based on configuration settings obtained or received by the UE. Such configuration settings may be received by the UE from a base station (e.g., the Rx base station), a location server, an RF sensing server, or the like. It should be noted that, in some implementations, the UE may be configured to perform a calibration process to ensure that the UE is capable of accurately measuring elapse of the predetermined time delay and/or transmitting a signal (e.g., a corresponding RS) after elapse of the predetermined time delay.

At 910, the functionality comprises transmitting a corresponding RS at a time point corresponding to the predetermined time delay duration after the time point at which the RF sensing RS was received (e.g., at block 906). Means for performing the functionality of block 910 comprise one or more hardware processors, one or more antennas, and/or any other components of the UE, as shown in FIG. 12.

In some implementations, the corresponding RS may have a waveform that is substantially similar to or the same as the RF sensing RS transmitted by the Tx base station. For example, in some implementations, the corresponding RS may have the same comb structure as the RF sensing RS, the same waveform as the RF sensing RS, or the like. In some implementations, the corresponding RS may have a watermark or other coding applied that distinguishes the corresponding RS from an echo of the RF sensing RS off of various passive objects. In one example, a watermark may comprise a phase shift of resource blocks of an OFDM communication scheme utilized in the RF sensing RS. In some embodiments, the same phase shift may be applied to all resource elements. In other embodiments, different resource blocks may have different amplitudes and/or phase shifts. In some implementations, the corresponding RS may be a legacy uplink signal, such as SRS. In some embodiments, a format of the corresponding RS may be indicated in configuration settings obtained by or received by the UE (e.g., from the base station, from a location server, from an RF sensing server, or the like).

It should be noted that, in instances in which the corresponding RS is different from the RF sensing RS (e.g., due to having a watermark or other precoding, due to being a legacy uplink signal, or the like), the predetermined time delay utilized at block 708 may be 0 or near 0, because, in such instances, the corresponding RS will not be mistaken as a spatial echo of the RF sensing RS.

At 912, the functionality comprises receiving, by the Rx base station, the corresponding RS. Means for performing the functionality of block 912 comprise one or more hardware processors, one or more antennas, and/or any other components of a base station, as shown in FIG. 13.

At 914, the functionality comprises determining a total range between the Tx base station, the UE, and the Rx base station. Means for performing the functionality at block 914 comprise one or more hardware processors, and/or any other components of a base station, as shown in FIG. 13. Referring to FIG. 8, the total range is represented by Rₛᵤₘ, where the total range is the sum of the range between the Tx base station and the UE and the range between the Rx base station and the UE.

At 916, the functionality comprises determining a distance between the Tx base station and the Rx base station. Means for performing the functionality at block 916 comprise one or more hardware processors, and/or any other components of a base station, as shown in FIG. 13. Referring to FIG. 8, the distance between the Tx base station and the Rx base station is represented by L. In some implementations, the distance between the Tx base station and the Rx base station may be determined using any suitable techniques, such as GNSS or NR based techniques. In one example, the distance may be determined using RTT positioning. In some implementations, the distance may be predetermined and stored for use during execution of process 900.

At 918, the functionality comprises determining a distance between the UE and the Rx base station. Means for performing the functionality at block 918 comprise one or more hardware processors, and/or any other components of a base station, as shown in FIG. 13. Referring to FIG. 8, the distance between the UE and the Rx base station is represented by R_{R}. In some implementations, the distance between the UE and the Rx base station may be determined based at least in part on the total range determined at block 914 and the distance between the Tx base station and the Rx base station. In some implementations, the distance between the UE and the Rx base station is determined based at least in part on a range between the first base station and the UE, which may be determined based on the total range. In some implementations, the distance between the UE and the Rx base station is determined based on an AoD of the RF sensing RS from the first base station, which may be determined based on RSRP measurements reported by the UE. More detailed techniques for determining the distance between the UE and the Rx base station are described above in connection with FIG. 8.

It should be noted that, in some implementations, a server, such as a location server or an RF sensing server that manages a sensing procedure, may determine the distance between the Rx base station and the UE. In some such implementations, blocks 914-918 may be omitted. In some such implementations, the Rx base station may report information to the server that is utilized by the server to determine the distance between the Rx base station and the UE, such as a time at which the corresponding RS was received at block 912, a time at which the RF sensing RS was received at block 906, a predetermined time delay δ utilized by the UE (if known by the Rx base station), and/or any other suitable information.

FIG. 10 illustrates an example flow diagram of a process 1000 for determining positioning information of a UE using an RF sensing procedure, according to an embodiment. Means for performing the functionality illustrated in one or more of the blocks shown in FIG. 10 may be performed by hardware components of a UE. Example components of a UE are illustrated in FIG. 12, which is described in more detail below.

At 1002, the functionality comprises receiving, at a UE from a network node, information indicative of a predetermined time delay to be utilized in connection with an RF sensing procedure utilizing UL and/or DL signals. Means for performing the functionality of block 1002 comprise one or more hardware processors, one or more antennas, and/or any other components of the UE, as shown in FIG. 12.

In some implementations, the information indicative of the predetermined time delay (generally referred to herein as δ) may be received in connection with configuration settings to be utilized by the UE. In some implementations, the configuration settings may indicate whether monostatic RF sensing or bistatic RF sensing is to be performed. In some implementations, the information indicative of the predetermined time delay may be received from a base station (e.g., an Rx base station, another serving base station, or the like) or a server (e.g., a location server, an RF sensing server that configures the UE to perform the RF sensing procedure described herein, or the like). It should be noted that, in some embodiments, the information indicative of the predetermined time delay may be received at any suitable time by the UE and stored in memory of the UE for future use during RF sensing procedures.

It should be noted that, in some implementations, the UE may receive other configuration information. For example, the UE may receive instructions indicating a type of signal to be utilized for transmitting a corresponding RS. As a more particular example, the instructions may indicate that the UE is to transmit a corresponding RS that is substantially the same as a received RF sensing RS. As another more particular example, the instructions may indicate that the UE is to transmit a corresponding RS that differs from the received RF sensing RS, for example, by applying a watermark or other precoding to the RF sensing RS (e.g., a phase shift of one or more resource blocks of the RF sensing RS, and/or any other suitable type of watermarking scheme), by utilizing a legacy uplink signal such as SRS, or the like. In such embodiments, the instructions may indicate that the predetermined time delay is to be 0 or near 0, because the corresponding RS will not be mistaken as a spatial echo of a received RF sensing RS.

It should be noted that, in some implementations, the UE may perform a calibration technique or a series of calibration techniques regarding the predetermined time delay. For example, in some embodiments, the calibration technique(s) may ensure that the UE can accurately measure the predetermined time delay. As another example, in some embodiments, the calibration technique(s) may ensure that the UE can accurately transmit a signal after elapse of the predetermined time delay.

In some implementations, the UE may receive the information indicative of the predetermined time delay responsive to the UE reporting (e.g., to a serving base station, to a location server, to an RF sensing server, or the like) that the UE is capable of performing the RF sensing techniques described herein.

At 1004, the functionality comprises receiving, at the UE, an RF sensing RS transmitted by a base station. Means for performing the functionality of block 1004 comprise one or more hardware processors, one or more antennas, and/or any other components of the UE, as shown in FIG. 12. In some implementations, the UE may record a time at which the RF sensing RS is received.

At 1006, the functionality comprises responsive to the predetermined time delay elapsing, transmitting a corresponding RF sensing RS, where a time at which the corresponding RF sensing RS is received and the predetermined time delay is usable to determine positioning information of the UE. Means for performing the functionality of block 1006 comprise one or more hardware processors, one or more antennas, and/or any other components of the UE, as shown in FIG. 12.

In instances in which monostatic RF sensing is performed, the positioning information of the UE may comprise a distance between the UE and the base station that transmitted the RF sensing RS received by the UE at block 1004. In some such implementations, the corresponding RF sensing RS may be received by the base station that transmitted the RF sensing RS. Continuing with this example, in some implementations, the base station may report timing information regarding a time at which the base station received the corresponding RF sensing RS to a server (e.g., a location server, an RF sensing server, or the like), where the server may determine a distance between the base station and the UE based on the time difference between when the base station received the corresponding RF sensing RS and the time the base station transmitting the RF sensing RS, and the predetermined time delay. Alternatively, in some implementations, the base station may determine the distance between the UE and the base station. Techniques for determining the distance between the base station and the UE when using a monostatic sensing procedure are shown in and described above in connection with FIG. 6.

In instances in which bistatic RF sensing is performed, the positioning information may comprise a distance between the UE and a base station other than the base station that transmitted the RF sensing RS received by the UE at block 1004, where the other base station is generally referred to herein as an Rx base station. In some such implementations, the corresponding RF sensing RS may be received by the Rx base station. Continuing with this example, the Rx base station may report timing information to a server (e.g., a location server, an RF sensing server, or the like), where the server may then determine the distance between the Rx base station and the UE based on the reported timing information and the predetermined time delay utilized by the UE. The timing information may include a time at which the Rx base station received the corresponding RS and/or a time at which the Rx base station received the RF sensing Rs. Alternatively, in some implementations, the Rx base station may determine the distance between the Rx base station and the UE. More detailed techniques for determining a distance between the Rx base station and the UE when a bistatic sensing procedure is performed are shown in and described above in connection with FIG. 8.

In some implementations, the corresponding RF sensing RS may have substantially the same waveform as the RF sensing RS received at block 1004. For example, in some implementations, the corresponding RF sensing RS may have the same comb structure as the RF sensing RS, the same waveform as the RF sensing RS, or the like. In some implementations, the corresponding RF sensing RS may be different from the RF sensing RS. For example, in some implementations, corresponding RF sensing RS may utilize a watermarking scheme such that the base station that receives the corresponding RF sensing RS can distinguish the corresponding RF sensing RS from echoes of the RF sensing RS from various passive objects in the environment. In some implementations, the watermark may utilize a precoding scheme. In one example, the watermark may comprise a phase shift of at least a portion of resource blocks of an OFDM communication scheme utilized in the RF sensing RS. In some examples, the same phase shift may be applied to all resource elements. In other examples, resource blocks may have different amplitudes and/or phase shifts. In some implementations, the watermarking scheme to be utilized by the UE may be provided to the UE by, for example, a serving base station, a server (e.g., a location server, an RF sensing server, or the like). As another example, in some implementations, the corresponding RS may be a legacy uplink signal, such as SRS. In some such implementations, the type legacy uplink signal to be used may be indicated to the UE by, for example, the serving base station, a server (e.g., a location server, an RF sensing server, or the like).

In some implementations, the UE may determine power characteristics of the corresponding RF sensing RS. For example, in some implementations, power characteristics may be determined based on path loss information associated with transmissions from the base station that receives the corresponding RF sensing RS. As a more particular example, responsive to the configuration settings indicating that the RF sensing procedure utilizes a monostatic configuration, process 1000 may determine power characteristics of the corresponding RF sensing RS based at least in part on path loss information determined based on transmissions from the base station that transmitted the RF sensing RS. As another more particular example, responsive to the configuration settings indicating that the RF sensing procedure utilizes a bistatic configuration, process 1000 may determine power characteristics of the corresponding RF sensing RS based at least in part on path loss information determined based on downlink transmissions from the Rx base station that is to receive the corresponding RF sensing RS.

As another example, in some implementations, power characteristics may be determined based on quasi-co-location (QCL) information that indicates that the corresponding RF sensing RS is QCLed with another signal. As a more particular example, in instances in which a monostatic sensing procedure is performed, the QCL information may indicate that the corresponding RF sensing RS is QCLed with a signal transmitted by the base station that transmitted the RF sensing RS and that is to receive the corresponding RF sensing RS. As another more particular example, in instances in which a bistatic sensing procedure is performed, the QCL information may indicate that the corresponding RF sensing RS is QCLed with a signal transmitted by an Rx base station that is to receive the corresponding RF sensing RS. It should be noted that, in some implementations, QCL information may be additionally or alternatively utilized to select a particular Rx beam to be used for reception of the RF sensing RS.

FIG. 11 illustrates an example flow diagram of a process 1100 for determining positioning information of a UE using an RF sensing procedure, according to an embodiment. Means for performing the functionality illustrated in one or more of the blocks shown in FIG. 11 may be performed by hardware components of a base station, such as an Rx base station. Example components of a base station are illustrated in FIG. 13, which is described in more detail below.

At 1102, the functionality comprises receiving, at a base station, configuration information indicating that an RF sensing procedure utilizing UL and DL signals is to occur. Means for performing the functionality of block 1102 comprise one or more hardware components, one or more antennas, and/or any other components of a base station, such as those depicted in FIG. 13. In some implementations, the configuration information may indicate a predetermined delay time utilized by a UE in connection with the RF sensing procedure. In some embodiments, the configuration information may indicate whether the RF sensing procedure is a bistatic procedure or a monostatic procedure. In some embodiments, in instances in which the configuration information indicates that a bistatic procedure is to be performed, the configuration information may indicate information about a Tx base station that is to transmit an RF sensing RS (e.g., an identifier associated with the Tx base station, location information associated with the Tx base station, or the like). In some embodiments, the configuration information may indicate whether a corresponding RS that is to be transmitted by a UE will be substantially the same as an RF sensing RS transmitted by a Tx base station, or, in cases in which the corresponding RS will differ from the RF sensing RS transmitted by the Tx base station, whether the corresponding RS will utilize a particular watermarking scheme or a legacy uplink signal, such as SRS.

It should be noted that, in some implementations, responsive to receiving the configuration information, process 1100 may transmit instructions to a UE to configure the UE to perform the RF sensing procedure. For example, in some embodiments, process 1100 may transmit an indication of the predetermined time delay to the UE. As another example, in some embodiments, process 1100 may transmit instructions to the UE to utilize a particular watermarking scheme and/or a particular legacy uplink signal.

At 1104, the functionality comprises receiving, at the base station, a corresponding RF sensing RS that was transmitted by a UE responsive to receiving an RF sensing RS and after a predetermined delay time elapsed at the UE, wherein the corresponding RF sensing RS was transmitted in connection with the RF sensing procedure. Means for performing the functionality of block 1104 comprise one or more hardware processors, one or more antennas, and/or any other components of a base station, for example, as depicted in FIG. 13. It should be noted that, in instances in which a bistatic procedure is being performed, the RF sensing RS may have been transmitted by a Tx base station that is different than the Rx base station executing process 1100. Conversely, in an instance in which a monostatic procedure is being performed, the RF sensing RS may have been transmitted by the base station executing process 1100.

At 1106, the functionality comprises: based at least in part on the configuration information, either 1) reporting, to a location server or RF sensing server, information indicative of the time the corresponding RF sensing RS was received, which is usable to determine a distance between the base station and the UE; or 2) determining, based on the time the corresponding RF sensing RS was received and the predetermined delay time, a distance between the base station and the UE. Means for performing the functionality of block 1106 comprise one or more hardware processors, one or more antennas, and/or any other components of a base station, for example, as depicted in FIG. 13.

In instances in which process 1100 reports, to the location server or RF sensing server, information indicative of the time the corresponding RF sensing RS was received, process 1100 may additionally report an indication of the predetermined time delay utilized by the UE. In other embodiments, the location server or RF sensing server may have a priori knowledge of the predetermined time delay (e.g., from configuring the UE). In some implementations, in instances in which bistatic sensing is performed, process 1100 may transmit other information to the location server or RF sensing server, such as a distance between the Rx base station executing process 1100 and the Tx base station that transmitted the RF sensing RS, an AoD of the RF sensing RS transmitted by the Tx base station, an AoA of the corresponding RF sensing RS transmitted by the UE, and/or any other suitable information.

In implementations in which process 1100 determines the distance between the base station and the UE, process 1100 may utilize any suitable techniques. For example, in instances in which a monostatic procedure is performed, process 1100 may utilize the techniques shown in and described above in connection with FIG. 6. As another example, in instances in which a bistatic procedure is performed, process 1100 may utilize the techniques shown in and described above in connection with FIG. 8. It should be noted that, in instances in which a bistatic procedure is performed, process 1100 may determine other information upon which the distance between the Rx base station and the UE is determined, such as a distance between the Rx base station executing process 1100 and the Tx base station that transmitted the RF sensing RS, an AoD of the RF sensing RS transmitted by the Tx base station, an AoA of the corresponding RF sensing RS transmitted by the UE, and/or any other suitable information.

FIG. 12 is a block diagram of an embodiment of a UE 105, which can be utilized as described herein above (e.g., in association with FIGS. 7, 9, and/or 10). For example, the UE 105 can perform one or more of the functions of the method shown in FIG. 10. It should be noted that FIG. 12 is meant only to provide a generalized illustration of various components, any or all of which may be utilized as appropriate. It can be noted that, in some instances, components illustrated by FIG. 12 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 12.

The UE 105 is shown comprising hardware elements that can be electrically coupled via a bus 1205 (or may otherwise be in communication, as appropriate). The hardware elements may include a processor(s) 1210 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1210 may comprise one or more processing units, which may be housed in a single integrated circuit (IC) or multiple ICs. As shown in FIG. 12, some embodiments may have a separate DSP 1220, depending on desired functionality. Location determination and/or other determinations based on wireless communication may be provided in the processor(s) 1210 and/or wireless communication interface 1230 (discussed below). The UE 105 also can include one or more input devices 1270, which can include without limitation one or more keyboards, touch screens, touch pads, microphones, buttons, dials, switches, and/or the like; and one or more output devices 1215, which can include without limitation one or more displays (e.g., touch screens), light emitting diodes (LEDs), speakers, and/or the like.

The UE 105 may also include a wireless communication interface 1230, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 105 to communicate with other devices as described in the embodiments above. The wireless communication interface 1230 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 1232 that send and/or receive wireless signals 1234. According to some embodiments, the wireless communication antenna(s) 1232 may comprise a plurality of discrete antennas, antenna arrays, or any combination thereof. The antenna(s) 1232 may be capable of transmitting and receiving wireless signals using beams (e.g., Tx beams and Rx beams). Beam formation may be performed using digital and/or analog beam formation techniques, with respective digital and/or analog circuitry. The wireless communication interface 1230 may include such circuitry.

Depending on desired functionality, the wireless communication interface 1230 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 105 may communicate with different data networks that may comprise various network types. For example, a Wireless Wide Area Network (WWAN) may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 105 can further include sensor(s) 1240. Sensor(s) 1240 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 105 may also include a Global Navigation Satellite System (GNSS) receiver 1280 capable of receiving signals 1284 from one or more GNSS satellites using an antenna 1282 (which could be the same as antenna 1232). Positioning based on GNSS signal measurement can be utilized to complement and/or incorporate the techniques described herein. The GNSS receiver 1280 can extract a position of the UE 105, using conventional techniques, from GNSS satellites 110 of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1280 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1280 is illustrated in FIG. 12 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1210, DSP 1220, and/or a processor within the wireless communication interface 1230 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), a hatch filter, particle filter, or the like. The positioning engine may also be executed by one or more processors, such as processor(s) 1210 or DSP 1220.

The UE 105 may further include and/or be in communication with a memory 1260. The memory 1260 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1260 of the UE 105 also can comprise software elements (not shown in FIG. 12), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1260 that are executable by the UE 105 (and/or processor(s) 1210 or DSP 1220 within UE 105). In some embodiments, then, such code and/or instructions can be used to configure and/or adapt a general-purpose computer (or other device) to perform one or more operations in accordance with the described methods.

FIG. 13 is a block diagram of an embodiment of a base station 120, which can be utilized as described herein above (e.g., in association with FIGS. 7, 9, and/or 11. It should be noted that FIG. 13 is meant only to provide a generalized illustration of various components, any or all of which may be utilized as appropriate. In some embodiments, the base station 120 may correspond to a gNB, an ng-eNB, and/or (more generally) a TRP.

The base station 120 is shown comprising hardware elements that can be electrically coupled via a bus 1305 (or may otherwise be in communication, as appropriate). The hardware elements may include a processor(s) 1310 which can include without limitation one or more general-purpose processors, one or more special-purpose processors (such as DSP chips, graphics acceleration processors, ASICs, and/or the like), and/or other processing structure or means. As shown in FIG. 13, some embodiments may have a separate DSP 1320, depending on desired functionality. Location determination and/or other determinations based on wireless communication may be provided in the processor(s) 1310 and/or wireless communication interface 1330 (discussed below), according to some embodiments. The base station 120 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The base station 120 might also include a wireless communication interface 1330, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the base station 120 to communicate as described herein. The wireless communication interface 1330 may permit data and signaling to be communicated (e.g., transmitted and received) to UEs, other base stations/TRPs (e.g., eNBs, gNBs, and ng-eNBs), and/or other network components, computer systems, and/or any other electronic devices described herein. The communication can be carried out via one or more wireless communication antenna(s) 1332 that send and/or receive wireless signals 1334.

The base station 120 may also include a network interface 1380, which can include support of wireline communication technologies. The network interface 1380 may include a modem, network card, chipset, and/or the like. The network interface 1380 may include one or more input and/or output communication interfaces to permit data to be exchanged with a network, communication network servers, computer systems, and/or any other electronic devices described herein.

In many embodiments, the base station 120 may further comprise a memory 1360. The memory 1360 can include, without limitation, local and/or network accessible storage, a disk drive, a drive array, an optical storage device, a solid-state storage device, such as a RAM, and/or a ROM, which can be programmable, flash-updateable, and/or the like. Such storage devices may be configured to implement any appropriate data stores, including without limitation, various file systems, database structures, and/or the like.

The memory 1360 of the base station 120 also may comprise software elements (not shown in FIG. 13), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1360 that are executable by the base station 120 (and/or processor(s) 1310 or DSP 1320 within base station 120). In some embodiments, then, such code and/or instructions can be used to configure and/or adapt a general-purpose computer (or other device) to perform one or more operations in accordance with the described methods.

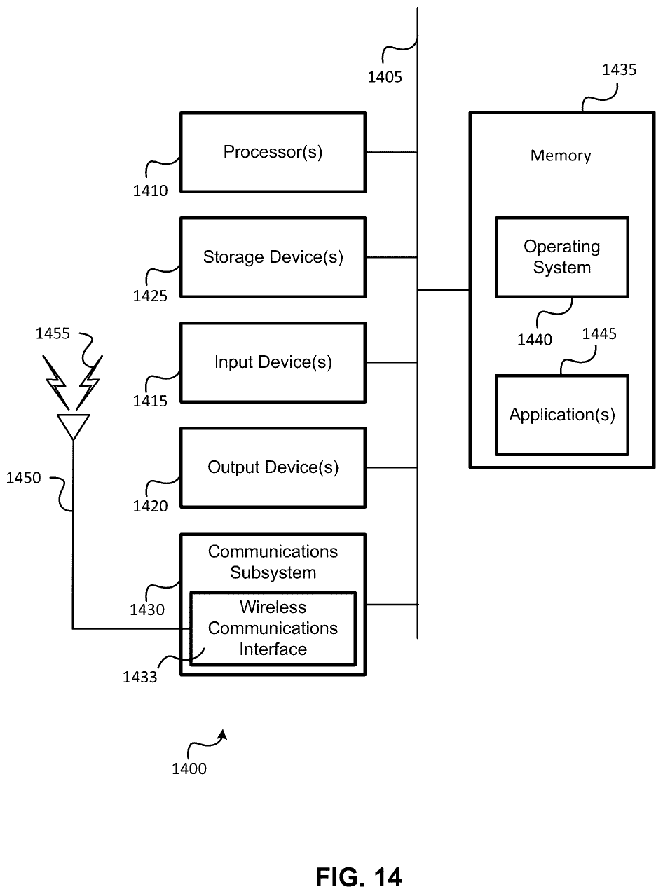

FIG. 14 is a block diagram of an embodiment of a computer system 1400, which may be used, in whole or in part, to provide the functions of one or more network components as described in the embodiments herein (e.g., location server 160 of FIG. 1). It should be noted that FIG. 14 is meant only to provide a generalized illustration of various components, any or all of which may be utilized as appropriate. FIG. 14, therefore, broadly illustrates how individual system elements may be implemented in a relatively separated or relatively more integrated manner. In addition, it can be noted that components illustrated by FIG. 14 can be localized to a single device and/or distributed among various networked devices, which may be disposed at different geographical locations.

The computer system 1400 is shown comprising hardware elements that can be electrically coupled via a bus 1405 (or may otherwise be in communication, as appropriate). The hardware elements may include processor(s) 1410, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1400 also may comprise one or more input devices 1415, which may comprise without limitation a mouse, a keyboard, a camera, a microphone, and/or the like; and one or more output devices 1420, which may comprise without limitation a display device, a printer, and/or the like.

The computer system 1400 may further include (and/or be in communication with) one or more non-transitory storage devices 1425, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1400 may also include a communications subsystem 1430, which may comprise wireless communication technologies managed and controlled by a wireless communication interface 1433, as well as wired technologies (such as Ethernet, coaxial communications, universal serial bus (USB), and the like). The wireless communication interface 1433 may comprise one or more wireless transceivers may send and receive wireless signals 1455 (e.g., signals according to 5G NR or LTE) via wireless antenna(s) 1450. Thus the communications subsystem 1430 may comprise a modem, a network card (wireless or wired), an infrared communication device, a wireless communication device, and/or a chipset, and/or the like, which may enable the computer system 1400 to communicate on any or all of the communication networks described herein to any device on the respective network, including a User Equipment (UE), base stations and/or other TRPs, and/or any other electronic devices described herein. Hence, the communications subsystem 1430 may be used to receive and send data as described in the embodiments herein.

In many embodiments, the computer system 1400 will further comprise a working memory 1435, which may comprise a RAM or ROM device, as described above. Software elements, shown as being located within the working memory 1435, may comprise an operating system 1440, device drivers, executable libraries, and/or other code, such as one or more applications 1445, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1425 described above. In some cases, the storage medium might be incorporated within a computer system, such as computer system 1400. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 1400 and/or might take the form of source and/or installable code, which, upon compilation and/or installation on the computer system 1400 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1. A method of performing RF sensing, the method comprising: receiving, at a User Equipment (UE) from a network node, information indicative of a predetermined time delay to be utilized in connection with an RF sensing procedure utilizing uplink (UL) and downlink (DL) signals; receiving, at the UE, an RF sensing reference signal (RS) transmitted by a base station; and responsive to the predetermined time delay elapsing, transmitting a corresponding RF sensing RS at a time corresponding to the predetermined time delay after a time at which the RF sensing RS was received, wherein a time at which the corresponding RF sensing RS is received and the predetermined time delay are usable to determine positioning information of the UE.

Clause 2. The method of clause 1, wherein the corresponding RF sensing RS has a same waveform as the RF sensing RS.

Clause 3. The method of clause 1 or 2, wherein the corresponding RF sensing RS comprises a phase-shifted version of the received RF sensing RS.

Clause 4. The method of any of clauses 1-3, further comprising responsive to receiving configuration information indicating that the RF sensing procedure utilizes a monostatic configuration, determining power characteristics of the corresponding RF sensing RS based at least in part on path loss information determined based on transmissions from the base station.

Clause 5. The method of any of clauses 1-3, further comprising responsive to receiving configuration information indicating that the RF sensing procedure utilizes a bistatic configuration, determining power characteristics of the corresponding RF sensing RS based at least in part on path loss information determined based on transmissions from a second base station.

Clause 6. The method of any of clauses 1-5, further comprising: receiving quasi-co-location (QCL) information indicating that the corresponding RF sensing RS is QCLed with a signal transmitted by the base station or a second base station; and configuring one or more characteristics of the corresponding RF sensing RS based on the QCL information.

Clause 7. The method of any of clauses 1-6, wherein the network node is a server. Clause 8. The method of any of clauses 1-7, wherein the network node is the base station.

Clause 9. The method of any of clauses 1-8, wherein the corresponding RF sensing RS is transmitted outside of symbol boundaries subject to the predetermined time delay.

Clause 10. The method of any of clauses 1-9, further comprising providing capability information indicating a capability of the UE to perform the RF sensing procedure utilizing uplink (UL) and downlink (DL) signals.

Clause 11. A method of performing RF sensing, the method comprising: receiving, at a base station, configuration information indicating that an RF sensing procedure utilizing uplink (UL) and downlink (DL) signals is to occur; receiving, at the base station, a corresponding RS that was transmitted by a UE responsive to receiving an RF sensing RS and after a predetermined delay time elapsed, wherein the corresponding RS was transmitted in connection with the RF sensing procedure; and based at least in part on the configuration information, either: 1) reporting, to a location server, information indicative of a time the corresponding RS was received, which is usable by the location server to determine a distance between the base station and the UE; or 2) determining, based on the time the corresponding RS was received and the predetermined delay time, the distance between the base station and the UE.

Clause 12. The method of clause 11, wherein the RF sensing RS received by the UE was transmitted by the base station.

Clause 13. The method of clause 12, wherein the information reported to the location server comprises a duration of time elapsed between transmitting the RF sensing RS and receiving the corresponding RS.

Clause 14. The method of clause 11, further comprising determining an angle of arrival (AoA) of the corresponding RS, wherein: (i) the AoA is reported to the location server; or (ii) a location of the UE is based at least in part on the AoA.

Clause 15. The method of any of clauses 11 or 14, wherein the RF sensing RS was transmitted by a second base station, and further comprising determining an angle of departure (AoD) of the RF sensing RS transmitted by the second base station based on reference signal received power (RSRP) information received from the UE, wherein (i) the AoD is reported to the location server; or (ii) a location of the UE is based at least in part on the AoD.

Clause 16. The method any of clauses 11, 14, or 15, wherein the RF sensing RS was transmitted by a second base station, and further comprising obtaining a distance between the base station and the second base station, wherein a location of the UE is based at least in part on the distance between the base station and the second base station.

Clause 17. The method of clause 16, wherein the distance between the base station and the second base station is determined using at least one of: global navigation satellite systems (GNSS) based positioning techniques, round trip time (RTT) positioning techniques, or any combination thereof.

Clause 18. The method of any of clauses 11-17, further comprising transmitting information indicative of the predetermined delay time to the UE.

Clause 19. A mobile device, comprising: a transceiver; a memory; and one or more processing units communicatively coupled with the transceiver and the memory, the one or more processing units configured to: receive, from a network node, information indicative of a predetermined time delay to be utilized in connection with an RF sensing procedure utilizing uplink (UL) and downlink (DL) signals; receive an RF sensing reference signal (RS) transmitted by a base station; and responsive to the predetermined time delay elapsing, transmit a corresponding RF sensing RS at a time corresponding to the predetermined time delay after a time at which the RF sensing RS was received, wherein a time at which the corresponding RF sensing RS is received and the predetermined time delay are usable to determine positioning information of the mobile device.

Clause 20. The mobile device of clause 19, wherein the one or more processing units are further configured to, responsive to receiving configuration information indicating that the RF sensing procedure utilizes a monostatic configuration, determine power characteristics of the corresponding RF sensing RS based at least in part on path loss information determined based on transmissions from the base station.

Clause 21. The mobile device of clause 19, wherein the one or more processing units are further configured to, responsive to receiving configuration information indicating that the RF sensing procedure utilizes a bistatic configuration, determine power characteristics of the corresponding RF sensing RS based at least in part on path loss information determined based on transmissions from a second base station.

Clause 22. The mobile device of any of clauses 19-21, wherein the one or more processing units are further configured to: receive quasi-co-location (QCL) information indicating that the corresponding RF sensing RS is QCLed with a signal transmitted by the base station or a second base station; and configure one or more characteristics of the corresponding RF sensing RS based on the QCL information.

Clause 23. The mobile device of any of clauses 19-22, wherein the one or more processing units are further configured to provide capability information indicating a capability of the UE to perform the RF sensing procedure utilizing uplink (UL) and downlink (DL) signals.

Clause 24. A base station, comprising: a transceiver; a memory; and one or more processing units communicatively coupled with the transceiver and the memory, the one or more processing units configured to: receive configuration information indicating that an RF sensing procedure utilizing uplink (UL) and downlink (DL) signals is to occur; receive a corresponding RS that was transmitted by a UE responsive to receiving an RF sensing RS and after a predetermined delay time elapsed, wherein the corresponding RS was transmitted in connection with the RF sensing procedure; and based at least in part on the configuration information, either: 1) report, to a location server, information indicative of a time the corresponding RS was received, which is usable by the location server to determine a distance between the base station and the UE; or 2) determine, based on the time the corresponding RS was received and the predetermined delay time, the distance between the base station and the UE.

Clause 25. The base station of clause 24, wherein the RF sensing RS received by the UE was transmitted by the base station.

Clause 26. The base station of clause 24, wherein the one or more processing units are further configured to determine an angle of arrival (AoA) of the corresponding RS, wherein: (i) the AoA is reported to the location server; or (ii) a location of the UE is based at least in part on the AoA.

Clause 27. The base station of any of clauses 24 or 26, wherein the RF sensing RS was transmitted by a second base station, and further comprising determining an angle of departure (AoD) of the RF sensing RS transmitted by the second base station based on reference signal received power (RSRP) information received from the UE, wherein (i) the AoD is reported to the location server; or (ii) a location of the UE is based at least in part on the AoD.

Clause 28. The base station of any of clauses 24, 26, or 27, wherein the RF sensing RS was transmitted by a second base station, and further comprising obtaining a distance between the base station and the second base station, wherein a location of the UE is based at least in part on the distance between the base station and the second base station.

Clause 29. The base station of clause 28, wherein the distance between the base station and the second base station is determined using at least one of: global navigation satellite systems (GNSS) based positioning techniques, round trip time (RTT) positioning techniques, or any combination thereof.

Clause 30. The base station of any of clauses 24-29, wherein the one or more processing units are further configured to transmit information indicative of the predetermined delay time to the UE.

What is claimed is:

1. A method of performing RF sensing, the method comprising:
receiving, at a User Equipment (UE) from a network node, information indicative of a predetermined time delay to be utilized in connection with an RF sensing procedure utilizing uplink (UL) and downlink (DL) signals;
receiving, at the UE, an RF sensing reference signal (RS) transmitted by a base station; and
responsive to the predetermined time delay elapsing, transmitting a corresponding RF sensing RS at a time corresponding to the predetermined time delay after a time at which the RF sensing RS was received, wherein a time at which the corresponding RF sensing RS is received and the predetermined time delay are usable to determine positioning information of the UE.

2. The method of claim 1, wherein the corresponding RF sensing RS has a same waveform as the RF sensing RS.

3. The method of claim 1, wherein the corresponding RF sensing RS comprises a phase-shifted version of the received RF sensing RS.

4. The method of claim 1, further comprising responsive to receiving configuration information indicating that the RF sensing procedure utilizes a monostatic configuration, determining power characteristics of the corresponding RF sensing RS based at least in part on path loss information determined based on transmissions from the base station.

5. The method of claim 1, further comprising responsive to receiving configuration information indicating that the RF sensing procedure utilizes a bistatic configuration, determining power characteristics of the corresponding RF sensing RS based at least in part on path loss information determined based on transmissions from a second base station.

6. The method of claim 1, further comprising:
receiving quasi-co-location (QCL) information indicating that the corresponding RF sensing RS is QCLed with a signal transmitted by the base station or a second base station; and
configuring one or more characteristics of the corresponding RF sensing RS based on the QCL information.

7. The method of claim 1, wherein the network node is a server.

8. The method of claim 1, wherein the network node is the base station.

9. The method of claim 1, wherein the corresponding RF sensing RS is transmitted outside of symbol boundaries subject to the predetermined time delay.

10. The method of claim 1, further comprising providing capability information indicating a capability of the UE to perform the RF sensing procedure utilizing uplink (UL) and downlink (DL) signals.

11. A method of performing RF sensing, the method comprising:
receiving, at a base station, configuration information indicating that an RF sensing procedure utilizing uplink (UL) and downlink (DL) signals is to occur;
receiving, at the base station, a corresponding RS that was transmitted by a UE responsive to receiving an RF sensing RS and after a predetermined delay time elapsed, wherein the corresponding RS was transmitted in connection with the RF sensing procedure; and
based at least in part on the configuration information, either: 1) reporting, to a location server, information indicative of a time the corresponding RS was received, which is usable by the location server to determine a distance between the base station and the UE; or 2) determining, based on the time the corresponding RS was received and the predetermined delay time, the distance between the base station and the UE.

12. The method of claim 11, wherein the RF sensing RS received by the UE was transmitted by the base station.

13. The method of claim 12, wherein the information reported to the location server comprises a duration of time elapsed between transmitting the RF sensing RS and receiving the corresponding RS.

14. The method of claim 11, further comprising determining an angle of arrival (AoA) of the corresponding RS, wherein: (i) the AoA is reported to the location server; or (ii) a location of the UE is based at least in part on the AoA.

15. The method of claim 11, wherein the RF sensing RS was transmitted by a second base station, and further comprising determining an angle of departure (AoD) of the RF sensing RS transmitted by the second base station based on reference signal received power (RSRP) information received from the UE, wherein (i) the AoD is reported to the location server; or (ii) a location of the UE is based at least in part on the AoD.

16. The method of claim 11, wherein the RF sensing RS was transmitted by a second base station, and further comprising obtaining a distance between the base station and the second base station, wherein a location of the UE is based at least in part on the distance between the base station and the second base station.

17. The method of claim 16, wherein the distance between the base station and the second base station is determined using at least one of: global navigation satellite systems (GNSS) based positioning techniques, round trip time (RTT) positioning techniques, or any combination thereof.

18. The method of claim 11, further comprising transmitting information indicative of the predetermined delay time to the UE.

19. A mobile device, comprising:
a transceiver;
a memory; and
one or more processing units communicatively coupled with the transceiver and the memory, the one or more processing units configured to:
receive, from a network node, information indicative of a predetermined time delay to be utilized in connection with an RF sensing procedure utilizing uplink (UL) and downlink (DL) signals;
receive an RF sensing reference signal (RS) transmitted by a base station; and
responsive to the predetermined time delay elapsing, transmit a corresponding RF sensing RS at a time corresponding to the predetermined time delay after a time at which the RF sensing RS was received, wherein a time at which the corresponding RF sensing RS is received and the predetermined time delay are usable to determine positioning information of the mobile device.

20. The mobile device of claim 19, wherein the one or more processing units are further configured to, responsive to receiving configuration information indicating that the RF sensing procedure utilizes a monostatic configuration, determine power characteristics of the corresponding RF sensing RS based at least in part on path loss information determined based on transmissions from the base station.

21. The mobile device of claim 19, wherein the one or more processing units are further configured to, responsive to receiving configuration information indicating that the RF sensing procedure utilizes a bistatic configuration, determine power characteristics of the corresponding RF sensing RS based at least in part on path loss information determined based on transmissions from a second base station.

22. The mobile device of claim 19, wherein the one or more processing units are further configured to:
receive quasi-co-location (QCL) information indicating that the corresponding RF sensing RS is QCLed with a signal transmitted by the base station or a second base station; and
configure one or more characteristics of the corresponding RF sensing RS based on the QCL information.

23. The mobile device of claim 19, wherein the one or more processing units are further configured to provide capability information indicating a capability of the UE to perform the RF sensing procedure utilizing uplink (UL) and downlink (DL) signals.

24. A base station, comprising:
a transceiver;
a memory; and
one or more processing units communicatively coupled with the transceiver and the memory, the one or more processing units configured to:
receive configuration information indicating that an RF sensing procedure utilizing uplink (UL) and downlink (DL) signals is to occur;
receive a corresponding RS that was transmitted by a UE responsive to receiving an RF sensing RS and after a predetermined delay time elapsed, wherein the corresponding RS was transmitted in connection with the RF sensing procedure; and
based at least in part on the configuration information, either: 1) report, to a location server, information indicative of a time the corresponding RS was received, which is usable by the location server to determine a distance between the base station and the UE; or 2) determine, based on the time the corresponding RS was received and the predetermined delay time, the distance between the base station and the UE.

25. The base station of claim 24, wherein the RF sensing RS received by the UE was transmitted by the base station.

26. The base station of claim 24, wherein the one or more processing units are further configured to determine an angle of arrival (AoA) of the corresponding RS, wherein: (i) the AoA is reported to the location server; or (ii) a location of the UE is based at least in part on the AoA.

27. The base station of claim 24, wherein the RF sensing RS was transmitted by a second base station, and further comprising determining an angle of departure (AoD) of the RF sensing RS transmitted by the second base station based on reference signal received power (RSRP) information received from the UE, wherein (i) the AoD is reported to the location server; or (ii) a location of the UE is based at least in part on the AoD.

28. The base station of claim 24, wherein the RF sensing RS was transmitted by a second base station, and further comprising obtaining a distance between the base station and the second base station, wherein a location of the UE is based at least in part on the distance between the base station and the second base station.

29. The base station of claim 28, wherein the distance between the base station and the second base station is determined using at least one of: global navigation satellite systems (GNSS) based positioning techniques, round trip time (RTT) positioning techniques, or any combination thereof.

30. The base station of claim 24, wherein the one or more processing units are further configured to transmit information indicative of the predetermined delay time to the UE.
